(19) United States
(12) Patent Application Publication
(10) Pub. No.: US 2015/0016522 A1
(43) Pub. Date: Jan. 15, 2015

(54) IMAGE PROCESSING APPARATUS AND IMAGE PROCESSING METHOD

(71) Applicant: Sony Corporation, Tokyo (JP)

(72) Inventor: Kazushi Sato, Kanagawa (JP)

(73) Assignee: SONY CORPORATION, Tokyo (JP)

(21) Appl. No.: 14/379,090

(22) PCT Filed: Feb. 27, 2013
(86) PCT No.: PCT/JP2013/055106

§ 371 Date: Aug. 15, 2014

(30) Foreign Application Priority Data
Apr. 5, 2012 (JP) 2012-086273

(51) Int. Cl. H04N 19/593; H04N 19/14; H04N 19/182

(52) U.S. Cl. CPC H04N 19/00763; H04N 19/00303; H04N 19/00157
USPC 375/240.12

(57) ABSTRACT

Provided is an image processing apparatus including a base layer prediction section that acquires prediction mode information for an intra prediction of a first prediction unit of a color difference component in a base layer of an image to be scalable-decoded, and an enhancement layer prediction section that, when the prediction mode information acquired by the base layer prediction section indicates a luminance based color difference prediction mode, generates a predicted image in the luminance based color difference prediction mode for a second prediction unit of the color difference component corresponding to the first prediction unit in an enhancement layer using coefficients calculated for the first prediction unit.

### TECHNICAL FIELD

The present disclosure relates to an image processing apparatus and an image processing method.

### BACKGROUND ART

The standardization of an image coding scheme called HEVC (High Efficiency Video Coding) by JCTVC (Joint Collaboration Team-Video Coding), which is a joint standardization organization of ITU-T and ISO/IEC, is currently under way for the purpose of improving coding efficiency more than H.264/AVC. For the HEVC standard. Committee draft as the first draft specifications was issued in February, 2012 (see, for example, Non-Patent Literature 1 below).

One important technology in image coding schemes including HEVC is an intra-screen prediction, that is, an intra prediction. The intra prediction is a technology that reduces the amount of information to be coded by using correlations between neighboring blocks in an image and predicting a pixel value in some block from pixel values of other neighboring blocks. For the intra prediction, the optimum prediction mode to predict pixel values of blocks to be predicted is normally selected from a plurality of prediction modes. In HEVC, for example, various prediction mode candidates such as the DC prediction, the angular prediction, and the planar prediction can be selected. For the intra prediction of a color difference component, an additional prediction mode called a linear model (LM) mode that predicts the pixel value of a color difference component using a dynamically constructed linear function of luminance components as a prediction function is also proposed (see Non-Patent Literature 2 below).

Incidentally, scalable video coding (SVC) is one of important technologies for future image coding schemes. The scalable video coding is a technology that hierarchically encodes a layer transmitting a rough image signal and a layer transmitting a fine image signal. Typical attributes hierarchized in the scalable video coding mainly include the following three:
Space scalability: Spatial resolutions or image sizes are hierarchized.
Time scalability: Frame rates are hierarchized.
SNR (Signal to Noise Ratio) scalability: SN ratios are hierarchized.

Further, though not yet adopted in the standard, the bit depth scalability and chroma format scalability are also discussed.

### CITATION LIST

### Non-Patent Literature

Non-Patent Literature 1: Benjamin Bross, Woo-Jin Han, Jens-Rainer Ohm. Gary J. Sullivan, Thomas Wiegand, “High efficiency video coding (HEVC) text specification draft 6” (JCTVC-H1003 ver21, Feb. 17, 2012)

Non-Patent Literature 2: Jianle Chen, et al. “CE6.a.4: Chroma intra prediction by reconstructed luma samples” (JCTVC-E266. March 2011)

### SUMMARY OF INVENTION

### Technical Problem

A process to calculate coefficients of a prediction function based on values of luminance values in LM mode proposed in Non-Patent Literature 2 needs more processing costs compared with operations of other prediction modes. Particularly the number of pixels included in a coefficient calculation process increases with an increasing size of the prediction unit and so the cost of the coefficient calculation process can be no longer ignored. Thus, adopting the LM mode for an upper layer in scalable video coding can contribute to improving coding efficiency, but at the same time, constitutes a risk factor of deterioration in performance.

Therefore, it is desirable to provide a mechanism capable of reducing the processing cost when the LM mode is adopted in scalable video coding.

### Solution to Problem

According to the present disclosure, there is provided an image processing apparatus including a base layer prediction section that acquires prediction mode information for an intra prediction of a first prediction unit of a color difference component in a base layer of an image to be scalable-decoded, and an enhancement layer prediction section that, when the prediction mode information acquired by the base layer prediction section indicates a luminance based color difference prediction mode, generates a predicted image in the luminance based color difference prediction mode for a second prediction unit of the color difference component corresponding to the first prediction unit in an enhancement layer using coefficients calculated for the first prediction unit.

The image processing apparatus mentioned above may be typically realized as an image decoding device that decodes an image.

According to the present disclosure, there is provided an image processing method including acquiring prediction mode information for an intra prediction of a first prediction unit of a color difference component in a base layer of an image to be scalable-decoded, and when the prediction mode information acquired indicates a luminance based color difference prediction mode, generating a predicted image in the luminance based color difference prediction mode for a second prediction unit of the color difference component corresponding to the first prediction unit in an enhancement layer using coefficients calculated for the first prediction unit.

According to the present disclosure, there is provided an image processing apparatus including a base layer prediction section that selects an optimum intra prediction mode for a first prediction unit of a color difference component in a base layer of an image to be scalable-encoded, and an enhancement layer prediction section that, when a luminance based color difference prediction mode is selected by the base layer prediction section for the first prediction unit, generates a predicted image in the luminance based color difference prediction mode for a second prediction unit of the color difference component corresponding to the first prediction unit in an enhancement layer using coefficients calculated for the first prediction unit.

The image processing apparatus mentioned above may be typically realized as an image encoding device that encodes an image.

According to the present disclosure, there is provided an image processing method including selecting an optimum intra prediction mode for a first prediction unit of a color difference component in a base layer of an image to be scalable-encoded, and when a luminance based color difference prediction mode is selected for the first prediction unit, generating a predicted image in the luminance based color difference prediction mode for a second prediction unit of the color difference component corresponding to the first prediction unit in an enhancement layer using coefficients calculated for the first prediction unit.

### Advantageous Effects of Invention

According to the present disclosure, the processing cost when the LM mode is adopted in scalable video coding can be reduced.

### BRIEF DESCRIPTION OF DRAWINGS

FIG. 1 is an explanatory view illustrating scalable video coding.

FIG. 2 is an explanatory view illustrating an LM mode.

FIG. 3 is a block diagram showing a schematic configuration of an image encoding device according to an embodiment.

FIG. 4 is a block diagram showing a schematic configuration of an image decoding device according to an embodiment.

FIG. 5 is a block diagram showing an example of the configuration of a first encoding section and a second encoding section shown in FIG. 3.

FIG. 6A is an explanatory view illustrating a first technique of the intra prediction in an upper layer when the LM mode is selected in a lower layer.

FIG. 6B is an explanatory view illustrating a second technique of the intra prediction in the upper layer when the LM mode is selected in the lower layer.

FIG. 6C is an explanatory view illustrating a third technique of the intra prediction in the upper layer when the LM mode is selected in the lower layer.

FIG. 6D is an explanatory view illustrating a fourth technique of the intra prediction in the upper layer when the LM mode is selected in the lower layer.

FIG. 7 is a block diagram showing an example of a detailed configuration of an intra prediction section shown in FIG. 5.

FIG. 8 is a flow chart showing an example of a schematic process flow for encoding according to an embodiment.

FIG. 9 is a flow chart showing an example of branching in an intra prediction process in the upper layer.

FIG. 10A is a flow chart showing an example of the flow of the intra prediction process for encoding performed in the upper layer according to the first technique when the LM mode is selected in the lower layer.

FIG. 10B is a flow chart showing an example of the flow of the intra prediction process for encoding performed in the upper layer according to the second technique when the LM mode is selected in the lower layer.

FIG. 10C is a flow chart showing an example of the flow of the intra prediction process for encoding performed in the upper layer according to the third technique when the LM mode is selected in the lower layer.

FIG. 10D is a flow chart showing an example of the flow of the intra prediction process for encoding performed in the upper layer according to the fourth technique when the LM mode is selected in the lower layer.

FIG. 11 is a block diagram showing an example of the configuration of a first decoding section and a second decoding section shown in FIG. 4.

FIG. 12 is a block diagram showing an example of the detailed configuration of an intra prediction section shown in FIG. 11.

FIG. 13 is a flow chart showing an example of the schematic process flow for decoding according to an embodiment.

FIG. 14 is a flow chart showing an example of branching in the intra prediction process in the upper layer.

FIG. 15A is a flow chart showing an example of the flow of the intra prediction process for decoding performed in the upper layer according to the first technique when the LM mode is specified in the lower layer.

FIG. 15B is a flow chart showing an example of the flow of the intra prediction process for decoding performed in the upper layer according to the second technique when the LM mode is specified in the lower layer.

FIG. 15C is a flow chart showing an example of the flow of the intra prediction process for decoding performed in the upper layer according to the third technique when the LM mode is specified in the lower layer.

FIG. 15D is a flow chart showing an example of the flow of the intra prediction process for decoding performed in the upper layer according to the fourth technique when the LM mode is specified in the lower layer.

FIG. 16 is a block diagram showing an example of a schematic configuration of a television.

FIG. 17 is a block diagram showing an example of a schematic configuration of a mobile phone.

FIG. 18 is a block diagram showing an example of a schematic configuration of a recording/reproduction device.

FIG. 19 is a block diagram showing an example of a schematic configuration of an image capturing device.

FIG. 20 is an explanatory view illustrating a first example of use of the scalable video coding.

FIG. 21 is an explanatory view illustrating a second example of use of the scalable video coding.

FIG. 22 is an explanatory view illustrating a third example of use of the scalable video coding.

FIG. 23 is an explanatory view illustrating a multi-view codec.

FIG. 24 is a block diagram showing a schematic configuration of the image encoding device for multi-view codec.

FIG. 25 is a block diagram showing a schematic configuration of the image decoding device for multi-view codec.

### DESCRIPTION OF EMBODIMENT

Hereinafter, preferred embodiments of the present disclosure will be described in detail below with reference to the appended drawings. Note that, in this specification and the drawings, elements that have substantially the same function and configuration are denoted with the same reference signs and a repeated explanation is omitted.

The description will be provided in the order shown below:

1. Overview

1-1. Scalable Video Coding

1-2. Luminance Based Color Difference Prediction Mode (LM Mode)

1-3. Basic Configuration Example of Encoder

1-4. Basic Configuration Example of Decoder

2. Configuration Example of Encoding Section According to an Embodiment

2-1. Overall Configuration

2-2. Various Techniques of Intra Prediction

2-3. Detailed Configuration of Intra Prediction Section

3. Process Flow for Encoding According to an Embodiment

4. Configuration Example of Decoding Section According to an Embodiment

4-1. Overall Configuration

4-2. Detailed Configuration of Intra Prediction Section

5. Process Flow for Decoding According to an Embodiment

6. Application Examples

6-1. Application to Various Products

6-2. Various Uses of Scalable Video Coding

6-3. Others

7. Summary

### 1. Overview

### 1-1. Scalable Video Coding

In the scalable video coding, a plurality of layers, each containing a series of images, is encoded. A base layer is a layer encoded first to represent roughest images. An encoded stream of the base layer may be independently decoded without decoding encoded streams of other layers. Layers other than the base layer are layers called enhancement layer representing finer images. Encoded streams of enhancement layers are encoded by using information contained in the encoded stream of the base layer. Therefore, to reproduce an image of an enhancement layer, encoded streams of both of the base layer and the enhancement layer are decoded. The number of layers handled in the scalable video coding may be any number equal to 2 or greater. When three layers or more are encoded, the lowest layer is the base layer and the remaining layers are enhancement layers. For an encoded stream of a higher enhancement layer, information contained in encoded streams of a lower enhancement layer and the base layer may be used for encoding and decoding. In this specification, of at least two layers having dependence, the layer on the side depended on is called a lower layer and the layer on the depending side is called an upper layer.

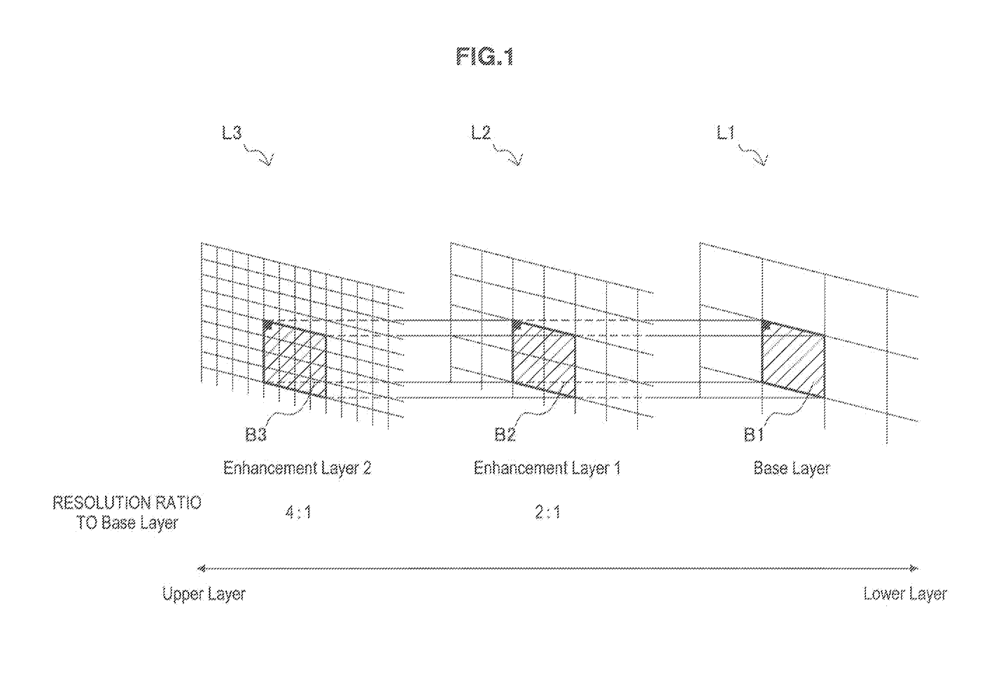

FIG. 1 shows three layers L1, L2, L3 subjected to scalable video coding. The layer L1 is the base layer and the layers L2, L3 are enhancement layers. Here, among various kinds of scalability, the space scalability is taken as an example. The ratio of spatial resolution of the layer L2 to the layer L1 is 2:1. The ratio of spatial resolution of the layer L3 to the layer L1 is 4:1. A block B1 of the layer L1 is a prediction unit inside a picture of the base layer. A block B2 of the layer L2 is a prediction unit inside a picture of an enhancement layer taking a scene common to the block B1. The block B2 corresponds to the block B1 of the layer L1. A block B3 of the layer L3 is a prediction unit inside a picture of a higher enhancement layer taking a scene common to the blocks B1 and B2. The block B3 corresponds to the block B1 of the layer L1 and the block B2 of the layer L2.

In such a layer structure, a spatial correlation of an image of some layer is normally similar to spatial correlations of images of other layers corresponding to a common scene. If, for example, the block B1 has a strong correlation with a neighboring block in some direction in the layer L1, it is likely that the block B2 has a strong correlation with a neighboring block in the same direction in the layer L2 and the block B3 has a strong correlation with a neighboring block in the same direction in the layer L3.

That spatial correlations of an image are similar between layers applies not only to space scalability illustrated in FIG. 1, but also to SNR scalability, bit depth scalability, and chroma format scalability. Among these, space scalability and chroma format scalability are characterized in that the resolution or component density of a color difference component is different between corresponding blocks of different layers. This feature may require consideration of some exceptional case when the LM mode described next is applied. The exceptional case will be described later. Though not limiting, the technology according to the present disclosure can be applied space scalability, SNR scalability, bit depth scalability, and chroma format scalability.

### 1-2. Luminance Based Color Difference Prediction Mode (LM Mode)

As described above, the luminance based color difference prediction mode to generate a predicted image of a color difference component based on luminance components of the same block is proposed in the standardization work of HEVC (High Efficiency Video Coding) as a prediction mode for the intra prediction of the color difference component. A linear function having dynamically calculated coefficients is used as a prediction function in the luminance based color difference prediction mode and thus, the prediction mode is also called a linear model (LM) mode. Arguments of a prediction function are values of luminance components (down-sampled when necessary) and the return value thereof is a predicted pixel value of the color difference component. More specifically, the prediction function in LM mode may be a linear function as shown below:

[Math. 1]

Pr_{C}[x,y]=αRe_{L}′[x,y]+β (1)

In Formula (1), Re_{L}′(x,y) represents a down-sampled value of the luminance component of a decoded image (so-called reconstructed image). Down-sampling (or phase shifting) of the luminance component may be performed when the density of the color difference component is different from that of the luminance component depending on the chroma format. α and β are coefficients calculated from pixel values of neighboring blocks using a predetermined formula.

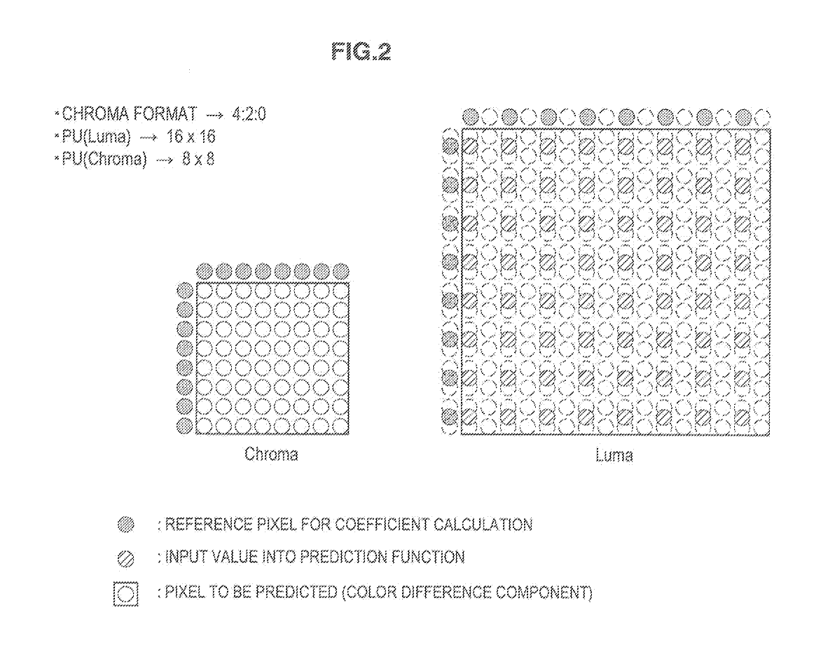

If, for example, FIG. 2 is referred to, the prediction unit (PU) of the luminance component (Luma) having the size of 16×16 pixels and PU of the corresponding color difference component (Chroma) when the chroma format is 4:2:0 are conceptually shown. The density of the luminance component is twice that of the color difference component for each of the horizontal direction and the vertical direction. Circles positioned around each PU and filled in, in FIG. 2, are reference pixels referred to when the coefficients α, β of the prediction function are calculated. Circles diagonally shaded on the right in FIG. 2 are down-sampled luminance components. By substituting values of down-sampled luminance components into the right side Re_{L}′(x,y) of the prediction function, the predicted value of the color difference component in a common pixel position is calculated. When the chroma format is 4:2:0, like the example in FIG. 2, an input value (value substituted into the prediction function) of one luminance component is generated by down-sampling for each (2×2) luminance components. Reference pixels can also be down-sampled in the same manner.

The coefficients α and β of the prediction function are calculated according to Formula (2) and Formula (3) respectively. I represents the number of reference pixels.

$$\begin{matrix}α = \frac{I \cdot {\sum }_{i = 0}^{I} {Re}_{C} ( i ) \cdot {Re}_{L}^{′} ( i ) - {\sum }_{i = 0}^{I} {Re}_{C} ( i ) \cdot {\sum }_{i = 0}^{I} {Re}_{L}^{′} ( i )}{I \cdot {\sum }_{i = 0}^{I} {Re}_{L}^{′} ( i ) \cdot {Re}_{L}^{′} ( i ) - {( {\sum }_{i = 0}^{I} {Re}_{L}^{′} ( i ) )}^{2}} & ( 2 ) \\ β = \frac{{\sum }_{i = 0}^{I} {Re}_{C} ( i ) - α \cdot {\sum }_{i = 0}^{I} {Re}_{L}^{′} ( i )}{I} & ( 3 )\end{matrix}$$

As is understood from Formula (2) and Formula (3), the calculation of the coefficients α and β of the prediction function in LM mode includes a no small number of times of arithmetic operations. As a result, the process to calculate coefficients of a prediction function in LM mode needs a lot of processing costs when compared with operations in other prediction modes. Particularly, the number of reference pixels I increases with an increasing size of the prediction unit and thus, the cost of the coefficient calculation process can no longer be ignored. Therefore, performing the coefficient calculation process for each layer repeatedly in scalable video coding is not advisable in view of performance.

To be noted here is that when scalability that makes spatial correlations of an image similar between layers is realized, correlations between the luminance component and the color difference component may also be similar between layers.

When coefficients of a prediction function in LM mode for some prediction unit in a lower layer are calculated, instead of recalculating coefficients of a prediction function for the corresponding prediction unit in an upper layer, the coefficients calculated for the lower layer can be reused. Accordingly, the processing cost can be reduced. Particularly, when the LM mode is selected as the optimum intra prediction mode for a prediction unit in the lower layer, a prediction function having the coefficients α and β calculated there may be said to represent the correlation between the luminance component and the color difference component in the prediction unit satisfactorily. If such a prediction function is reused for the corresponding prediction unit in the upper layer, the processing cost can be reduced and at the same time, the precision of prediction in the upper layer can be maintained at a high level.

Incidentally, an upper limit can be imposed on the size of the prediction unit of the color difference component that can be used by the aforementioned LM mode. In HEVC, the upper limit is 16×16 pixels. On the other hand, when space scalability or chroma format scalability is realized, the size of some prediction unit of the color difference component in the upper layer is larger than the size of the corresponding prediction unit in the lower layer. Thus, if the LM mode is selected for the prediction unit of, for example, 16×16 pixels in the lower layer, a situation in which the LM mode is not available for the corresponding prediction unit in the upper layer may arise. As will be described later, the technology according to the present disclosure also provides the possibility of reusing coefficients of a prediction function in LM mode of the lower layer even in such a situation.

### 1-3. Basic Configuration Example of Encoder

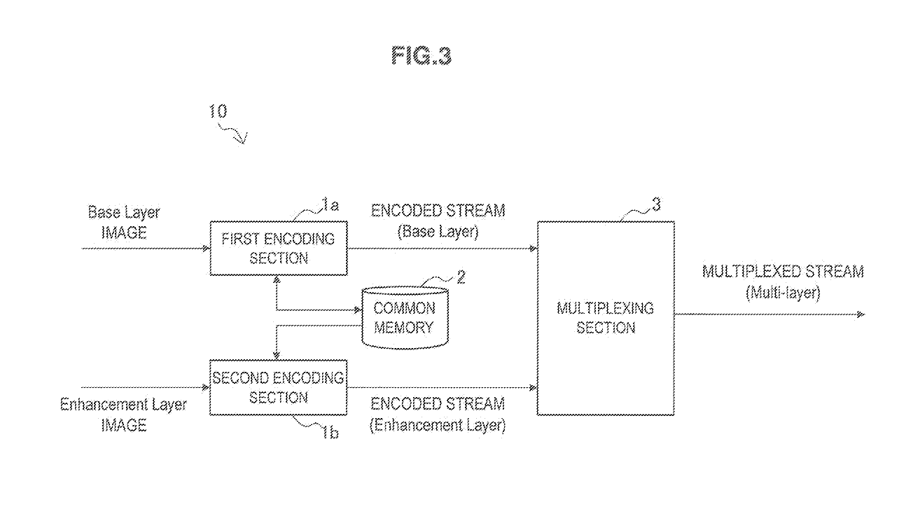

FIG. 3 is a block diagram showing a schematic configuration of an image encoding device 10 according to an embodiment supporting scalable video coding. Referring to FIG. 3, the image encoding device 10 includes a first encoding section 1a, a second encoding section 1b, a common memory 2, and a multiplexing section 3.

The first encoding section 1a encodes a base layer image to generate an encoded stream of the base layer. The second encoding section 1b encodes an enhancement layer image to generate an encoded stream of an enhancement layer. The common memory 2 stores information commonly used between layers. The multiplexing section 3 multiplexes an encoded stream of the base layer generated by the first encoding section 1a and an encoded stream of at least one enhancement layer generated by the second encoding section 1b to generate a multilayer multiplexed stream.

### 1-4. Basic Configuration Example of Decoder

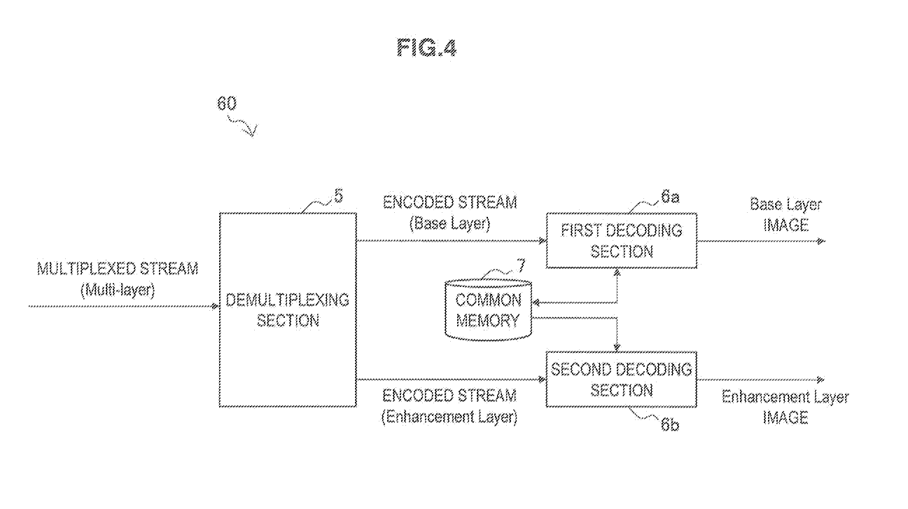

FIG. 4 is a block diagram showing a schematic configuration of an image decoding device 60 according to an embodiment supporting scalable video coding. Referring to FIG. 4, the image decoding device 60 includes a demultiplexing section 5, a first decoding section 6a, a second decoding section 6b, and a common memory 7.

The demultiplexing section 5 demultiplexes a multilayer multiplexed stream into an encoded stream of the base layer and an encoded stream of at least one enhancement layer. The first decoding section 6a decodes a base layer image from an encoded stream of the base layer. The second decoding section 6b decodes an enhancement layer image from an encoded stream of an enhancement layer. The common memory 7 stores information commonly used between layers.

In the image encoding device 10 illustrated in FIG. 3, the configuration of the first encoding section 1a to encode the base layer and that of the second encoding section 1b to encode an enhancement layer are similar to each other. Some parameters generated or acquired by the first encoding section 1a are buffered by using the common memory 2 and reused by the second encoding section 1b. In the next section, such a configuration of the first encoding section 1a and the second encoding section 1b will be described in detail.

Similarly, in the image decoding device 60 illustrated in FIG. 4, the configuration of the first decoding section 6a to decode the base layer and that of the second decoding section 6b to decode an enhancement layer are similar to each other. Some parameters generated or acquired by the first decoding section 6a are buffered by using the common memory 7 and reused by the second decoding section 6b. Further in the next section, such a configuration of the first decoding section 6a and the second decoding section 6b will be described in detail.

### 2. Configuration Example of Encoding Section According to an Embodiment

### 2-1. Overall Configuration

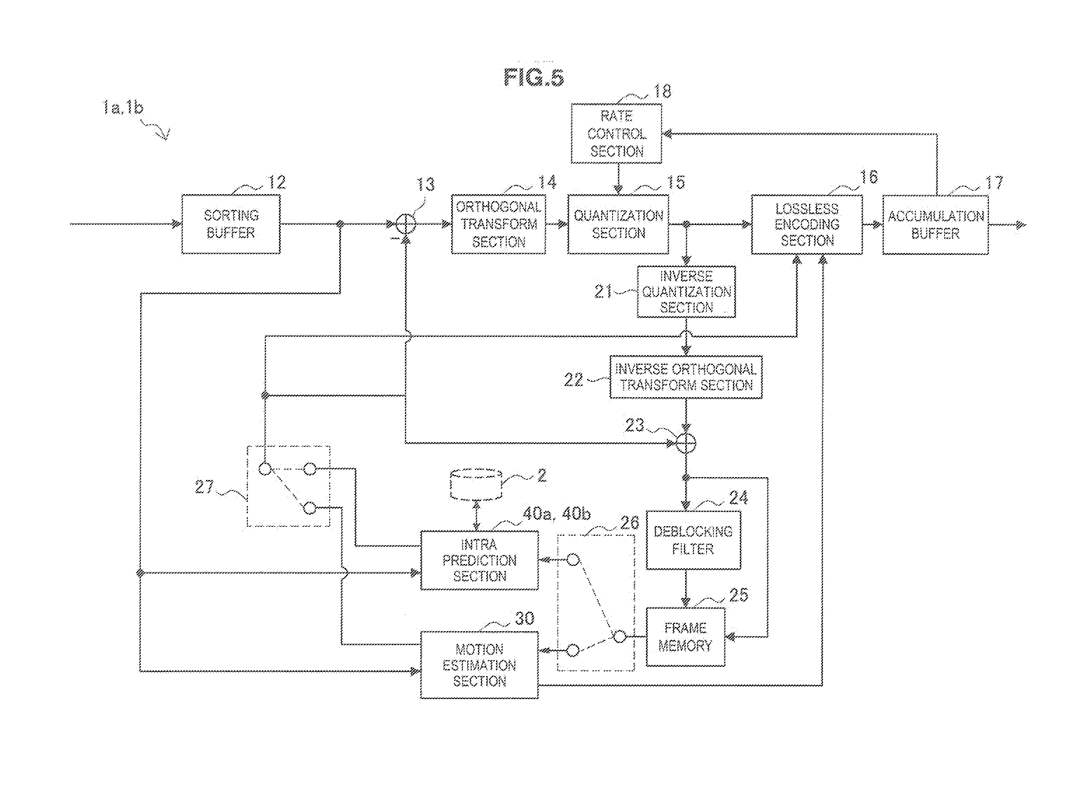

FIG. 5 is a block diagram showing an example of the configuration of the first encoding section 1a and the second encoding section 1b shown in FIG. 3. Referring to FIG. 5, the first encoding section 1a includes a sorting buffer 12, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a deblocking filter 24, a frame memory 25, selectors 26, 27, a motion estimation section 30, and an intra prediction section 40a. The second encoding section 1b includes, instead of the intra prediction section 40a, an intra prediction section 40b.

The sorting buffer 12 sorts the images included in the series of image data. After sorting the images according to a GOP (Group of Pictures) structure according to the encoding process, the sorting buffer 12 outputs the image data which has been sorted to the subtraction section 13, the motion estimation section 30 and the intra prediction section 40a or 40b.

The image data input from the sorting buffer 12 and predicted image data input by the motion estimation section 30 or the intra prediction section 40a or 40b described later are supplied to the subtraction section 13. The subtraction section 13 calculates predicted error data which is a difference between the image data input from the sorting buffer 12 and the predicted image data and outputs the calculated predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (DCT) or Karhunen-Loeve transform, for example. The orthogonal transform section 14 outputs transform coefficient data acquired by the orthogonal transform process to the quantization section 15.

The transform coefficient data input from the orthogonal transform section 14 and a rate control signal from the rate control section 18 described later are supplied to the quantization section 15. The quantization section 15 quantizes the transform coefficient data, and outputs the transform coefficient data which has been quantized (hereinafter, referred to as quantized data) to the lossless encoding section 16 and the inverse quantization section 21. Also, the quantization section 15 switches a quantization parameter (a quantization scale) based on the rate control signal from the rate control section 18 to thereby change the bit rate of the quantized data.

The lossless encoding section 16 generates an encoded stream of each layer by performing a lossless encoding process on quantized data of each layer input from the quantization section 15. The lossless encoding section 16 also encodes information about an intra prediction or information about an inter prediction input from the selector 27 and multiplexes encoded parameters into the header region of an encoded stream. Then, the lossless encoding section 16 outputs the generated encoded stream to the accumulation buffer 17.

The accumulation buffer 17 temporarily accumulates an encoded stream input from the lossless encoding section 16 using a storage medium such as a semiconductor memory. Then, the accumulation buffer 17 outputs the accumulated encoded stream to a transmission section (not shown) (for example, a communication interface or an interface to peripheral devices) at a rate in accordance with the band of a transmission path.

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21 performs an inverse quantization process on the quantized data input from the quantization section 15. Then, the inverse quantization section 21 outputs transform coefficient data acquired by the inverse quantization process to the inverse orthogonal transform section 22.

The inverse orthogonal transform section 22 performs an inverse orthogonal transform process on the transform coefficient data input from the inverse quantization section 21 to thereby restore the predicted error data. Then, the inverse orthogonal transform section 22 outputs the restored predicted error data to the addition section 23.

The addition section 23 adds the restored predicted error data input from the inverse orthogonal transform section 22 and the predicted image data input from the motion estimation section 30 or the intra prediction section 40a or 40b to thereby generate decoded image data (so-called reconstructed image). Then, the addition section 23 outputs the generated decoded image data to the deblocking filter 24 and the frame memory 25.

The deblocking filter 24 performs a filtering process for reducing block distortion occurring at the time of encoding of an image. The deblocking filter 24 filters the decoded image data input from the addition section 23 to remove the block distortion, and outputs the decoded image data after filtering to the frame memory 25.

The frame memory 25 stores, using a storage medium, the decoded image data input from the addition section 23 and the decoded image data after filtering input from the deblocking filter 24.

The selector 26 reads the decoded image data after filtering which is to be used for inter prediction from the frame memory 25, and supplies the decoded image data which has been read to the motion estimation section 30 as reference image data. Also, the selector 26 reads the decoded image data before filtering which is to be used for intra prediction from the frame memory 25, and supplies the decoded image data which has been read to the intra prediction section 40a or 40b as reference image data.

In the inter prediction mode, the selector 27 outputs predicted image data as a result of inter prediction output from the motion estimation section 30 to the subtraction section 13 and also outputs information about the inter prediction to the lossless encoding section 16. In the intra prediction mode, the selector 27 outputs predicted image data as a result of intra prediction output from the intra prediction section 40a or 40b to the subtraction section 13 and also outputs information about the intra prediction to the lossless encoding section 16. The selector 27 switches the inter prediction mode and the intra prediction mode in accordance with the magnitude of a cost function value output from the motion estimation section 30 and the intra prediction section 40a or 40b.

The motion estimation section 30 performs an inter prediction process (inter-frame prediction process) based on image data (original image data) to be encoded and input from the sorting buffer 12 and decoded image data supplied via the selector 26. For example, the motion estimation section 30 evaluates prediction results in each prediction mode using a predetermined cost function. Next, the motion estimation section 30 selects the prediction mode in which the cost function value takes the minimum value, that is, the prediction mode in which the compression rate is the highest as the optimum prediction mode. Also, the motion estimation section 30 generates predicted image data according to the optimum prediction mode. Then, the motion estimation section 30 outputs prediction mode information indicating the selected optimum prediction mode, information about the inter prediction including motion vector information and reference pixel information, the cost function value, and predicted image data to the selector 27.

The intra prediction section 40a performs an intra prediction process for each prediction unit based on original image data and decoded image data of the base layer. For example, the intra prediction section 40a evaluates prediction results in each prediction mode using a predetermined cost function. Next, the intra prediction section 40a selects the prediction mode in which the cost function value is minimum, that is, the compression rate is the highest as the optimum prediction mode. Also, the intra prediction section 40a generates predicted image data of the base layer according to the optimum prediction mode. Then, the intra prediction section 40a outputs information about the intra prediction including prediction mode information indicating the selected optimum prediction mode, the cost function value, and predicted image data to the selector 27. Also, the intra prediction section 40a causes the common memory 2 to buffer at least a portion of parameters about the intra prediction.

The intra prediction section 40b performs the intra prediction process for each prediction unit based on original image data and decoded image data of an enhancement layer. For example, the intra prediction section 40b evaluates prediction results in each prediction mode using a predetermined cost function. Next, the intra prediction section 40b selects the prediction mode in which the cost function value is minimum, that is, the compression rate is the highest as the optimum prediction mode. Also, the intra prediction section 40b generates predicted image data of an enhancement layer according to the optimum prediction mode. Then, the intra prediction section 40b outputs information about the intra prediction including prediction mode information indicating the selected optimum prediction mode, the cost function value, and predicted image data to the selector 27. Also, the intra prediction section 40b omits at least a portion of the intra prediction process of an enhancement layer by reusing parameters buffered by the common memory 2.

The first encoding section 1a performs a series of encoding processes described here on a sequence of image data of the base layer. The second encoding section 1b performs a series of encoding processes described here on a sequence of image data of an enhancement layer. When a plurality of enhancement layers is present, the encoding process of the enhancement layer can be repeated as many times as the number of enhancement layers. The encoding process of the base layer and that of an enhancement layer may be performed by being synchronized in the processing unit, for example, the encoding unit or the prediction unit.

### 2-2. Various Techniques of Intra Prediction

Two useful methods are available to reuse coefficients of a prediction function in LM mode calculated in a lower layer for an upper layer. One is a method of fixedly selecting the LM mode for the upper layer when the LM mode is selected for the lower layer without re-estimating the prediction mode for the upper layer. When a predicted pixel value of the color difference component in LM mode is calculated for the upper layer, a prediction function having coefficients calculated for the lower layer are reused. In this specification, this method is called the LM mode fixing method. The other is a method of reusing coefficients calculated for the lower layer as coefficients of a prediction function in LM mode to re-estimate the prediction mode in the upper layer when the LM mode is selected for the lower layer. In this specification, this method is called the re-estimation method.

Two methods of how to handle the LM mode in the upper layer are available when, assuming space scalability or chroma format scalability, the size of the prediction unit of the color difference component in the lower layer is equal to the maximum size in which the LM mode can be used. One is a method of dividing the prediction unit in the upper layer into a plurality of sub-blocks having a size in which the LM mode can be used. In this specification, this method is called the division method. The other is a method of inhibiting the use of the LM mode for the corresponding prediction unit in the upper layer. In this specification, this method is called the LM mode inhibition method.

Therefore, four techniques combining the LM mode fixing method/re-estimation method and the division method/LM mode inhibition mode. These four techniques will be described below. In the description that follows, it is assumed as an example, instead of limitation, that the resolution ratio between layers is 1:2 and the maximum size of the prediction unit in which the LM mode can be used is 16×16 pixels.

(1) First Technique

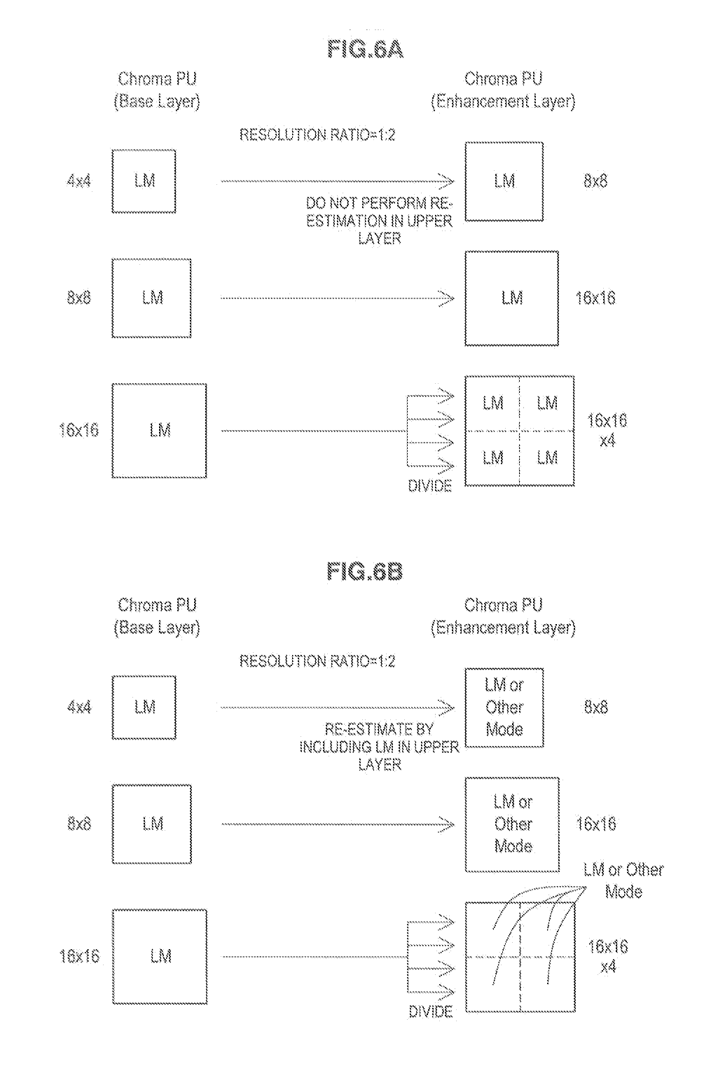

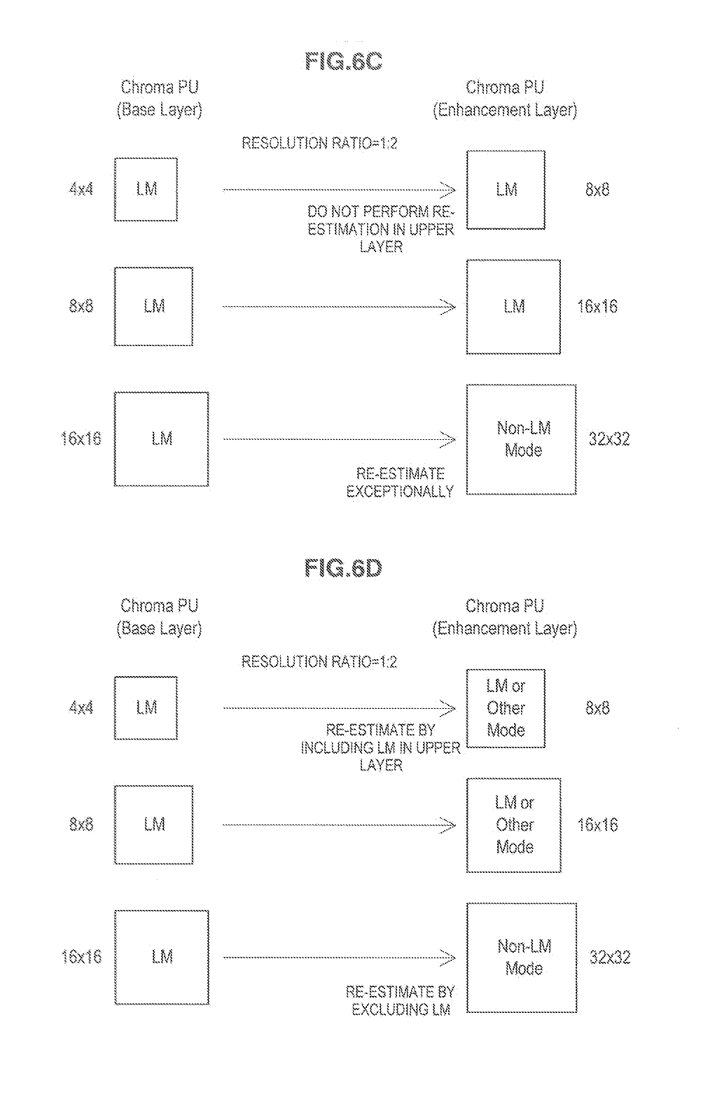

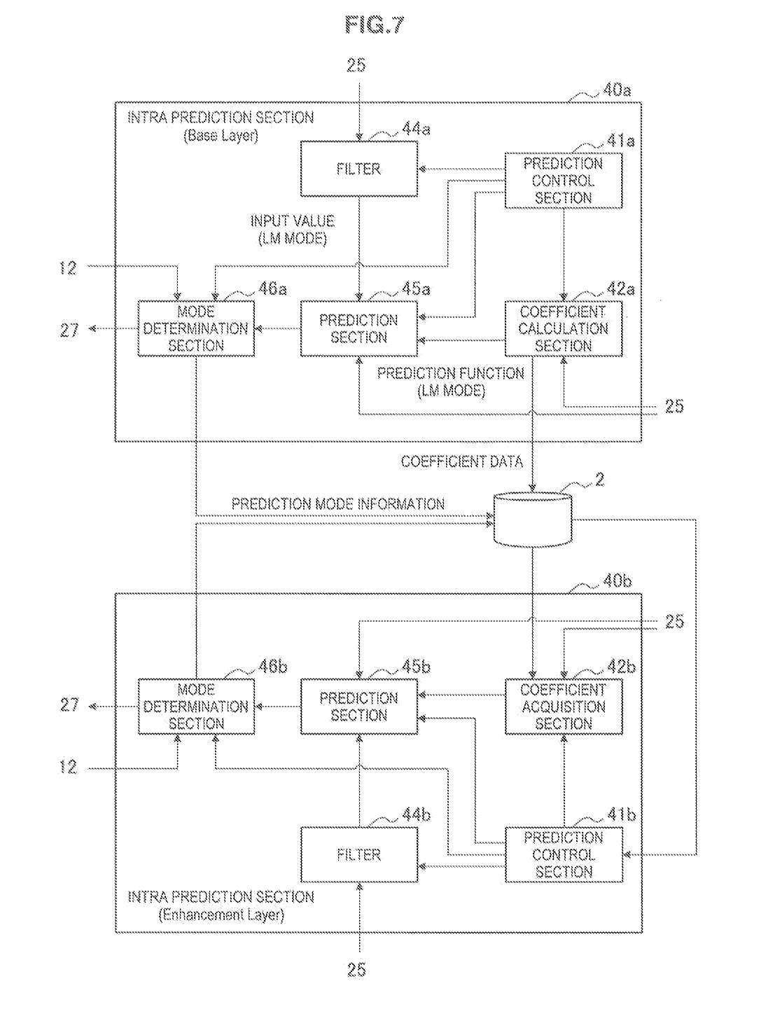

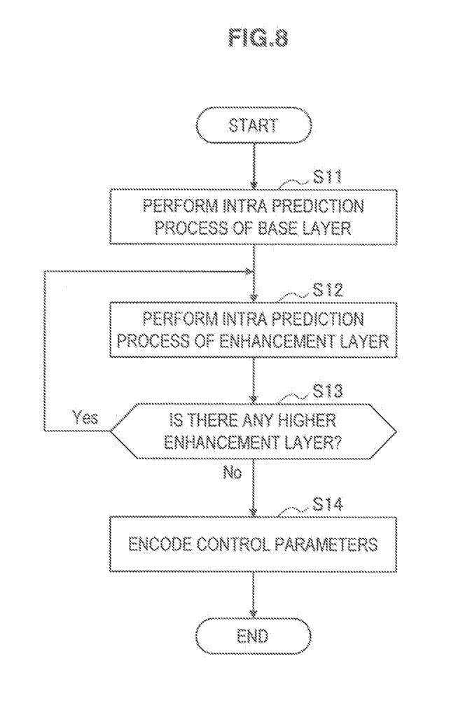

FIG. 6A is an explanatory view illustrating a first technique of the intra prediction in an upper layer when the LM mode is selected in a lower layer. The first technique is a combination of the LM mode fixing method and the division method.

According to the first technique, when the LM mode is selected for the prediction unit of 4×4 pixels in the lower layer, the LM mode is also selected fixedly for the corresponding prediction unit of 8×8 pixels in the upper layer. When the LM mode is selected for the prediction unit of 8×8 pixels in the lower layer, the LM mode is also selected fixedly for the corresponding prediction unit of 16×16 pixels in the upper layer. In both cases, a predicted image in the upper layer is generated by using a prediction function in LM mode having the coefficients α, β calculated in the lower layer. When the LM mode is selected for the prediction unit of 16×16 pixels in the lower layer, the corresponding prediction unit of 32×32 pixels in the upper layer into four sub-blocks of 16×16 pixels. Then, a predicted image of each sub-block is generated by using a prediction function having the coefficients α, β calculated in the lower layer.

In the first technique, when the LM mode is selected in the lower layer, the LM mode fixing method is adopted and thus, it is unnecessary to encode prediction mode information in the upper layer. Thus, coding efficiency of an encoded stream in the upper layer is improved. Because not only the calculation of coefficients of a prediction function, but also the re-estimation of the prediction mode is omitted in the upper layer, the processing cost of intra prediction of the upper layer can significantly be reduced. In addition, the division method is adopted and thus, a predicted image can be generated in LM mode in the upper layer regardless of the size of the prediction unit in the lower layer without extending a processing module of the LM mode so that a larger block size is supported. Therefore, the precision of prediction in the upper layer can be maintained at a high level.

(2) Second Technique

FIG. 6B is an explanatory view illustrating a second technique of the intra prediction in the upper layer when the LM mode is selected in the lower layer. The second technique is a combination of the re-estimation method and the division method.

In the second technique, the optimum prediction mode is re-estimated from a plurality of prediction modes including the LM mode for the prediction unit in the upper layer. Then, prediction mode information indicating the optimum prediction mode is encoded inside an encoded stream of the upper layer. When the LM mode is selected for the prediction unit of 4×4 pixels or 8×8 pixels in the lower layer, a prediction function having the coefficients α, β calculated in the lower layer is used when a predicted pixel value in LM mode is generated for the re-estimation in the upper layer. When the LM mode is selected for the prediction unit of 16×16 pixels in the lower layer, the corresponding prediction unit of 32×32 pixels in the upper layer is divided into four sub-blocks of 16×16 pixels when a predicted pixel value in LM mode is generated for the re-estimation in the upper layer. Then, a predicted image of each sub-block is generated by using a prediction function having the coefficients α, β calculated in the lower layer.

In the second technique, the prediction mode is re-estimation in the upper layer and therefore, the optimum prediction mode can be selected also in the upper layer regardless of the prediction mode selected for the lower layer. In addition, the division method is adopted and thus, the LM mode can be included as an estimation object in the upper layer regardless of the size of the prediction unit in the lower layer without extending a processing module of the LM mode so that a larger block size is supported. Therefore, the precision of prediction in the upper layer can be maintained at a high level.

(3) Third Technique

FIG. 6C is an explanatory view illustrating a third technique of the intra prediction in the upper layer when the LM mode is selected in the lower layer. The third technique is a combination of the LM mode fixing method and the LM mode inhibition method.

In the third technique, when the LM mode is selected for the prediction unit of 4×4 pixels in the lower layer, the LM mode is also selected fixedly for the corresponding prediction unit of 8×8 pixels in the upper layer. When the LM mode is selected for the prediction unit of 8×8 pixels in the lower layer, the LM mode is also selected fixedly for the corresponding prediction unit of 16×16 pixels in the upper layer. In both cases, a predicted image in the upper layer is generated by using a prediction function in LM mode having the coefficients α, β calculated in the lower layer. When the LM mode is selected for the prediction unit of 16×16 pixels in the lower layer, the optimum prediction mode is exceptionally re-estimated from a plurality of prediction modes excluding the LM mode for the corresponding prediction unit of 32×32 pixels in the upper layer. Then, prediction mode information indicating the optimum prediction mode is encoded inside an encoded stream of the upper layer.

In the third technique, when the LM mode is selected in the lower layer, excluding the above exceptional case, the LM mode fixing method is adopted and thus, it is unnecessary to encode prediction mode information in the upper layer.

Thus, coding efficiency of an encoded stream in the upper layer is improved. In addition, due to omission of the re-estimation of the prediction mode, the processing cost of intra prediction of the upper layer can be reduced. Because the LM mode is inhibited for the prediction unit having a size exceeding the maximum size in which the LM mode can be used, there is no need to extend the processing module in LM mode.

(4) Fourth Technique

FIG. 6D is an explanatory view illustrating a fourth technique of the intra prediction in the upper layer when the LM mode is selected in the lower layer. The fourth technique is a combination of the re-estimation method and the LM mode inhibition method.

In the fourth technique, when the LM mode is selected for the prediction unit of 4×4 pixels or 8×8 pixels in the lower layer, the optimum prediction mode is re-estimated from a plurality of prediction modes including the LM mode for the corresponding prediction unit in the upper layer. A prediction function having the coefficients α, β calculated in the lower layer is used when a predicted pixel value in LM mode is generated for the re-estimation in the upper layer. Then, prediction mode information indicating the optimum prediction mode is encoded inside an encoded stream of the upper layer. When the LM mode is selected for the prediction unit of 16×16 pixels in the lower layer, the optimum prediction mode is exceptionally re-estimated from a plurality of prediction modes excluding the LM mode for the corresponding prediction unit of 32×32 pixels in the upper layer. Then, prediction mode information indicating the optimum prediction mode is encoded inside an encoded stream of the upper layer.

In the fourth technique, the prediction mode is re-estimated in the upper layer and therefore, the optimum prediction mode can be selected also in the upper layer regardless of the prediction mode selected for the lower layer. Because the LM mode is inhibited for the prediction unit having a size exceeding the maximum size in which the LM mode can be used, there is no need to extend the processing module in LM mode.

### 2-3. Detailed Configuration of Intra Prediction Section

FIG. 7 is a block diagram showing an example of a detailed configuration of the intra prediction sections 40a, 40b shown in FIG. 5. Referring to FIG. 7, the intra prediction section 40a includes a prediction control section 41a, a coefficient calculation section 42a, a filter 44a, a prediction section 45a, and a mode determination section 46a. The intra prediction section 40b includes a prediction control section 41b, a coefficient acquisition section 42b, a filter 44b, a prediction section 45b, and a mode determination section 46b.

(1) Intra Prediction Process of the Base Layer

The prediction control section 41a of the intra prediction section 40a controls the intra prediction process of the base layer. For example, the prediction control section 41a performs the intra prediction process for the luminance component (Y) and the intra prediction process for the color difference component (Cb, Cr) for each prediction unit (PU). In the intra prediction process for the luminance component, the prediction control section 41a causes the prediction section 45a to generate a predicted image in each prediction unit in a plurality of prediction modes and causes the mode determination section 46a to determine the optimum prediction mode of the luminance component. In the intra prediction process for the color difference component, the prediction control section 41a causes the prediction section 45a to generate a predicted image in each prediction unit in a plurality of prediction modes including the LM mode and causes the mode determination section 46a to determine the optimum prediction mode of the color difference component. If the maximum size of the prediction unit exceeds the predetermined maximum size, the LM mode can be excluded from estimation candidates for the prediction unit.

The coefficient calculation section 42a calculates coefficients of a prediction function used by the prediction section 45a in LM mode according to the above Formula (2) and Formula (3) with reference to reference pixels in neighboring blocks adjacent to the prediction unit to be predicted.

The filter 44a generates an input value into the prediction function in LM mode by down-sampling (phase shifting) pixel values of the luminance component of the prediction unit to be predicted input from the frame memory 25 in accordance with the chroma format under the control of the prediction control section 41a. Then, the filter 44a outputs the generated input value to the prediction section 45a.

The prediction section 45a generates a predicted image of each prediction unit for each color component (that is, the luminance component and the color difference component) according to various prediction mode candidates under the control of the prediction control section 41a. Prediction mode candidates of the color difference component include the aforementioned LM mode. In LM mode, the prediction section 45a predicts the value of each color difference component by substituting the input value of the luminance component generated by the filter 44a into a prediction function having coefficients generated by the coefficient calculation section 42a. Intra predictions by the prediction section 45a in other prediction modes may be made in the same manner as existing techniques. The prediction section 45a outputs predicted image data generated as a result of prediction to the mode determination section 46a for each prediction mode.

The mode determination section 46a calculates the cost function value for each prediction mode based on original image data input from the sorting buffer 12 and predicted image data input from the prediction section 45a. Then, the mode determination section 46a selects the optimum prediction mode for each color component based on the calculated cost function value. Then, the mode determination section 46a outputs information about the intra prediction including prediction mode information indicating the selected optimum prediction mode, the cost function value, and predicted image data of each color component to the selector 27.

The mode determination section 46a also stores prediction mode information indicating the optimum prediction mode for each prediction unit in the base layer in a mode information buffer provided in the common memory 2. The coefficient calculation section 42a stores calculated coefficient values of the prediction function in a coefficient buffer provided in the common memory 2 at least for each prediction unit for which the LM mode is selected.

(2) Intra Prediction Process of an Enhancement Layer

The prediction control section 41b of the intra prediction section 40b controls the intra prediction process of an enhancement layer. For example, the prediction control section 41b performs the intra prediction process for the luminance component (Y) and the intra prediction process for the color difference component (Cb, Cr) for each prediction unit (PU). In the intra prediction process for the luminance component, the prediction control section 41b may cause the prediction section 45b and the mode determination section 46b to re-estimate the optimum prediction mode from a plurality of prediction modes. Instead, the prediction control section 41b may omit the re-estimation and apply the prediction mode selected for some prediction unit in the lower layer to the corresponding prediction unit in the upper layer.

The intra prediction process for the color difference component is controlled by the prediction control section 41b according to one of the aforementioned first to fourth techniques.

In the first technique, for example, when the LM mode is selected for a first prediction unit in the lower layer, the prediction control section 41b applies the LM mode also to a corresponding second prediction unit in the upper layer without estimating the prediction mode for the second prediction unit. More specifically, the coefficient acquisition section 42b acquires coefficients calculated for the first prediction unit from the common memory 2 under the control of the prediction control section 41b. The filter 44b generates an input value into the prediction function in LM mode by down-sampling pixel values of the luminance component in accordance with the chroma format. The prediction section 45b generates a predicted image of the second prediction unit in LM mode using the prediction function having the coefficients acquired by the coefficient acquisition section 42b. The mode determination section 46b outputs the predicted image data in LM mode to the selector 27 without evaluating the cost function value.

If the spatial resolution of the color difference component or the density of the color different component in an upper layer is higher than in a lower layer (that is, space scalability or chroma format scalability is realized), an exceptional process is performed in accordance with the size of the second prediction unit. More specifically, when the size of the second prediction unit exceeds the maximum size (for example, 16×16 pixels) in which the LM mode can be used, the prediction control section 41b divides the second prediction unit into a plurality of sub-blocks. Then, the prediction section 45b generates each predicted image of the plurality of sub-blocks in LM mode using the prediction function having the coefficients acquired by the coefficient acquisition section 42b.

In the second technique, when the LM mode is selected for the first prediction unit in the lower layer, the prediction control section 41b re-estimates the optimum prediction mode from the LM mode and other prediction modes for the corresponding second prediction unit in the upper layer. During the re-estimation, the prediction section 45b generates a predicted image of the second prediction unit in LM mode using the prediction function having the coefficients acquired by the coefficient acquisition section 42b from the common memory 2 and calculated for the first prediction unit. The mode determination section 46b selects the optimum prediction mode for the second prediction unit based on cost function values of a plurality of prediction modes including the LM mode. Then, the mode determination section 46b outputs information about the intra prediction and predicted image data to the selector 27.

If the size of the second prediction unit exceeds the maximum size when the spatial resolution of the color difference component or the density of the color different component in the upper layer is higher than in the lower layer, the prediction control section 41b divides the second prediction unit into a plurality of sub-blocks to estimate the optimum prediction mode. Then, the prediction section 45b generates each predicted image of the plurality of sub-blocks in LM mode using the prediction function having the coefficients acquired by the coefficient acquisition section 42b.

In the third technique, when the LM mode is selected for the first prediction unit in the lower layer, the prediction control section 41b applies the LM mode also to the corresponding second prediction unit in the upper layer without estimating the prediction mode for the second prediction unit. More specifically, the prediction section 45b generates a predicted image of the second prediction unit in LM mode using the prediction function having the coefficients acquired by the coefficient acquisition section 42b from the common memory 2 and calculated for the first prediction unit. The mode determination section 46b outputs the predicted image data in LM mode to the selector 27 without evaluating the cost function value.

If the size of the second prediction unit exceeds the maximum size when the spatial resolution of the color difference component or the density of the color different component in the upper layer is higher than in the lower layer, the prediction control section 41b re-estimates the optimum prediction mode from a plurality of prediction modes excluding the LM mode. In this case, the mode determination section 46b exceptionally evaluates the cost function value to select the optimum prediction mode for the second prediction unit.

In the fourth technique, when the LM mode is selected for the first prediction unit in the lower layer, the prediction control section 41b re-estimates the optimum prediction mode from the LM mode and other prediction modes for the corresponding second prediction unit in the upper layer. During the re-estimation, the prediction section 45b generates a predicted image of the second prediction unit in LM mode using the prediction function having the coefficients acquired by the coefficient acquisition section 42b from the common memory 2 and calculated for the first prediction unit. The mode determination section 46b selects the optimum prediction mode for the second prediction unit based on cost function values of a plurality of prediction modes. Then, the mode determination section 46b outputs information about the intra prediction and predicted image data to the selector 27.

If the size of the second prediction unit exceeds the maximum size when the spatial resolution of the color difference component or the density of the color different component in the upper layer is higher than in the lower layer, the prediction control section 41b excludes the LM mode from estimation objects of the optimum prediction mode.

If a higher enhancement layer remains regardless of the adopted technique, the mode determination section 46a stores prediction mode information indicating the selected prediction mode for each prediction unit in the mode information buffer provided in the common memory 2. Coefficients stored in the coefficient buffer in the common memory 2 can be retained until the intra prediction for all layers is completed.

(3) Encoded Parameters

For the introduction of technology according to the present disclosure, some additional parameters may be encoded inside an encoded stream by the lossless encoding section 16. Here, three parameters of a coefficient reuse flag, a mode fixing flag, and a division flag will be described.

The coefficient reuse flag is a parameter indicating whether coefficients calculated for the first prediction unit in the lower layer are reused for the corresponding second prediction unit in the upper layer. When the coefficient reuse flag inside an encoded stream indicates the reuse of coefficients, a decoder reuses coefficients of a prediction function in LM mode calculated in the lower layer for the upper layer. When the coefficient reuse flag inside an encoded stream indicates the non-reuse of coefficients, the decoder may recalculate coefficients in the upper layer.

The mode fixing flag is a parameter that indicates, when the LM mode is selected for the first prediction unit in the lower layer, whether new prediction mode information is encoded for the corresponding second prediction unit in the upper layer. The mode fixing flag may be understood as a parameter to switch between the LM mode fixing method and the re-estimation method described above. If the mode fixing flag indicates that no new prediction mode information is encoded for the second prediction unit when the LM mode is selected for the first prediction unit, the decoder applies the LM mode to the second prediction unit without acquiring prediction mode information. If the mode fixing flag indicates that new prediction mode information is encoded for the second prediction unit, the decoder acquires prediction mode information indicating the prediction mode selected for the second prediction unit from an encoded stream and makes an intra prediction according to the acquired prediction mode information.

The division flag is a parameter that indicates, if the size of the second prediction unit in the upper layer corresponding to the first prediction unit exceeds the predetermined maximum size when the LM mode is selected for the first prediction unit in the lower layer, whether the second prediction unit is to be divided into a plurality of sub-blocks. The division flag may be understood as a parameter to switch between the division method and the LM mode inhibition method described above. When the division flag indicates that the second prediction unit is to be divided into a plurality of sub-blocks, the decoder makes an intra prediction in LM mode for each of sub-blocks generated by dividing the second prediction unit. When the division flag indicates that the second prediction unit is not to be divided into a plurality of sub-blocks, the decoder acquires prediction mode information indicating the prediction mode (non-LM mode) selected for the second prediction unit from an encoded stream and makes an intra prediction according to the acquired prediction mode information.

These parameters may be introduced as dedicated parameters for the aforementioned individual purposes or integrated into parameters having other purposes. For example, a parameter indicating a profile of an encoded stream or a device level may be defined to have a function of the aforementioned coefficient reuse flag, mode fixing flag, or division flag. These parameters may be encoded in any position inside an encoded stream, for example, in a sequence parameter set, a picture parameter set, a slice header or the like.

### 3. Process Flow for Encoding According to an Embodiment

In this section, the process flow for encoding will be described using FIGS. 8 to 10D.

(1) Schematic Flow

FIG. 8 is a flow chart showing an example of a schematic process flow for encoding according to an embodiment.

Referring to FIG. 8, first the intra prediction section 40a for the base layer performs the intra prediction process of the base layer (step S11). The intra prediction process here may be processing according to specifications as defined in, for example, Non-Patent Literature 1 described above. Parameters reused between layers can be buffered by using the common memory 2.

Next, the intra prediction section 40b for an enhancement layer performs the intra prediction process of the enhancement layer (step S12). Parameters reused between layers can be reused by the intra prediction section 40b after being read from the common memory 2.

Next, when a plurality of enhancement layers is present, whether an upper enhancement layer that is not yet processed remains is determined (step S13). If an upper enhancement layer that is not yet processed remains, the intra prediction process in step S12 is repeated for the upper enhancement layer.

Then, control parameters are encoded inside an encoded stream by the lossless encoding section 16 (step S14). Control parameters encoded here may include any parameter such as the aforementioned coefficient reuse flag, mode fixing flag, and division flag and also prediction mode information. Encoding of parameters may be performed as part of the intra prediction process for each layer.

(2) Branching of the Intra Prediction Process

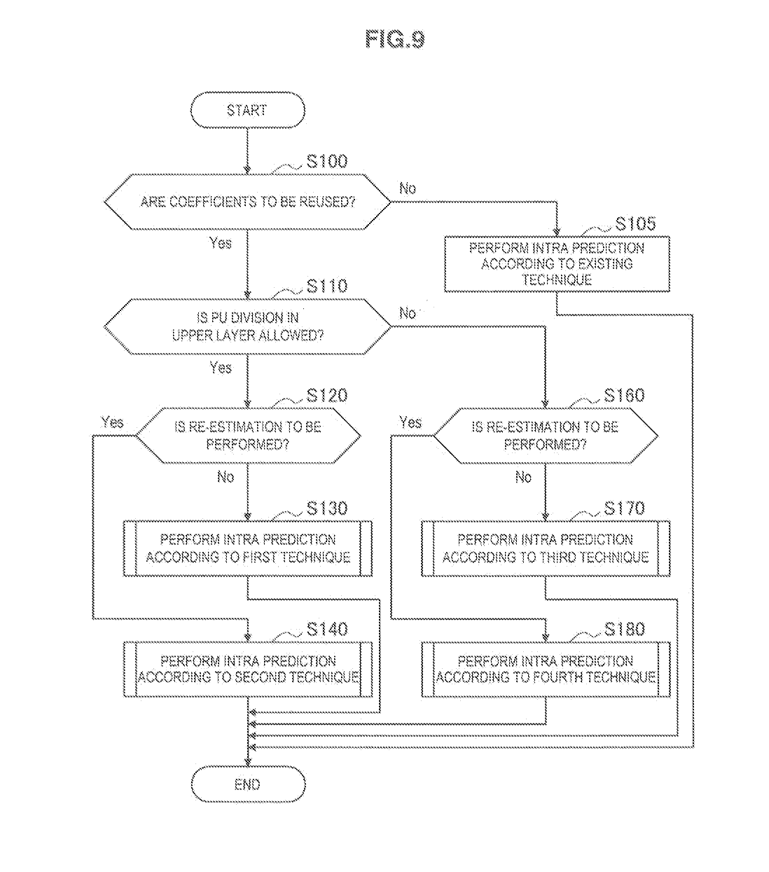

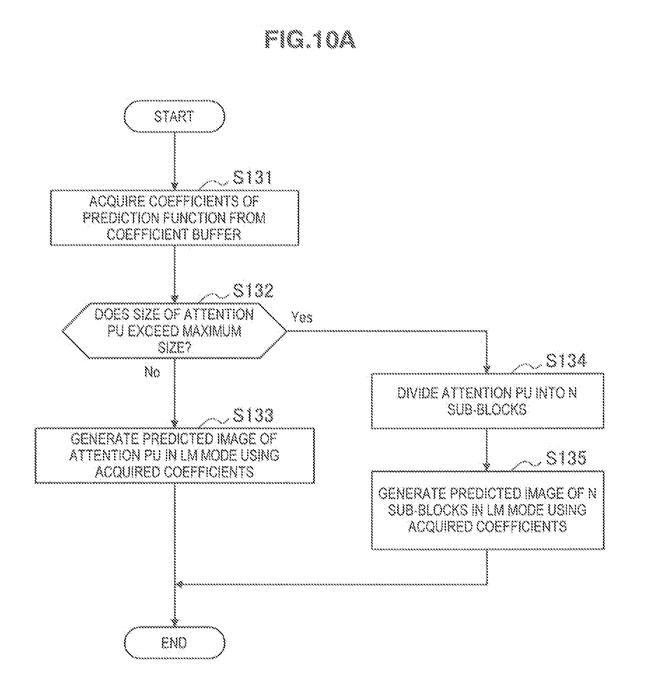

The image encoding device 10 may support only of the first to fourth techniques described above or a plurality of techniques of these techniques. When a plurality of techniques is supported, the prediction control section 41b of the intra prediction section 40b can determine for each process which technique to use to perform the intra prediction process of an enhancement layer. FIG. 9 illustrates such a determination of branching.

Referring to FIG. 9, the prediction control section 41b first determines whether to reuse coefficients of a prediction function in LM mode (step S100). This determination may be made according to various conditions, for example, user instructions, device settings, advance image analysis, and expected performance.

When coefficients of a prediction function in LM mode are not reused, the prediction control section 41b performs the intra prediction process of an enhancement layer according to an existing technique, instead of the first to fourth techniques described above (step S105).

When coefficients of a prediction function in LM mode are reused, the prediction control section 41b determines whether to allow the division of the prediction unit in the upper layer (step S110). Further, the prediction control section 41b determines whether to perform a re-estimation in the upper layer (steps S120, S160).

When the division of the prediction unit is allowed and no re-estimation is performed, the prediction control section 41b performs the intra prediction process of an enhancement layer according to the first technique described above (that is, a combination of the LM mode fixing method and the division method) (step S130).

When the division of the prediction unit is allowed and a re-estimation is performed, the prediction control section 41b performs the intra prediction process of an enhancement layer according to the second technique described above (that is, a combination of the re-estimation method and the division method) (step S140).

When the division of the prediction unit is not allowed and no re-estimation is performed, the prediction control section 41b performs the intra prediction process of an enhancement layer according to the third technique described above (that is, a combination of the LM mode fixing method and the LM mode inhibition method) (step S170).

When the division of the prediction unit is not allowed and a re-estimation is performed, the prediction control section 41b performs the intra prediction process of an enhancement layer according to the fourth technique described above (that is, a combination of the re-estimation method and the LM mode inhibition method) (step S180).

(3) First Technique

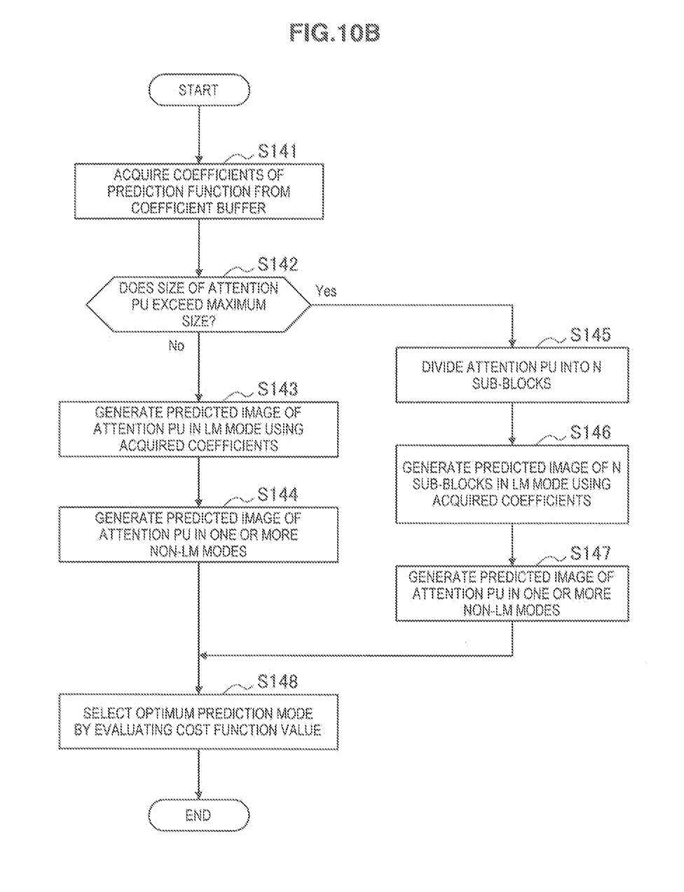

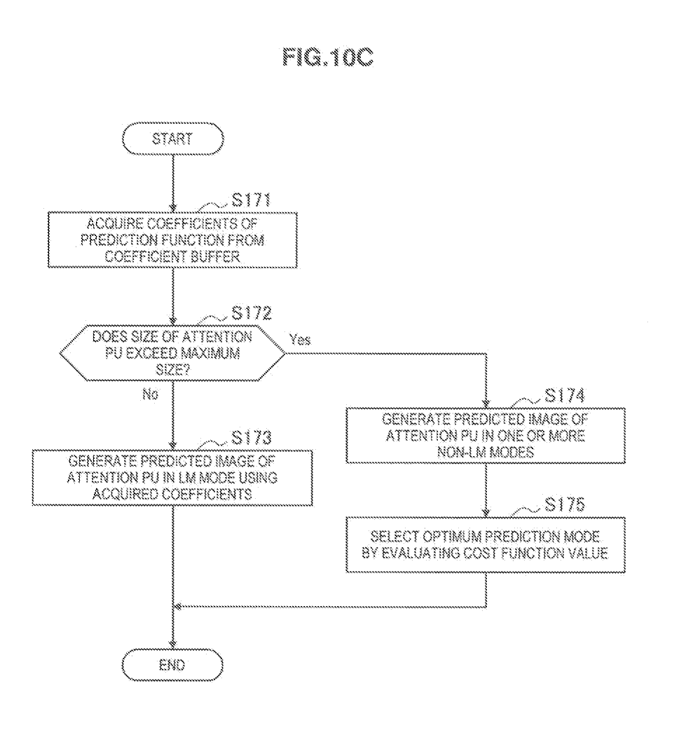

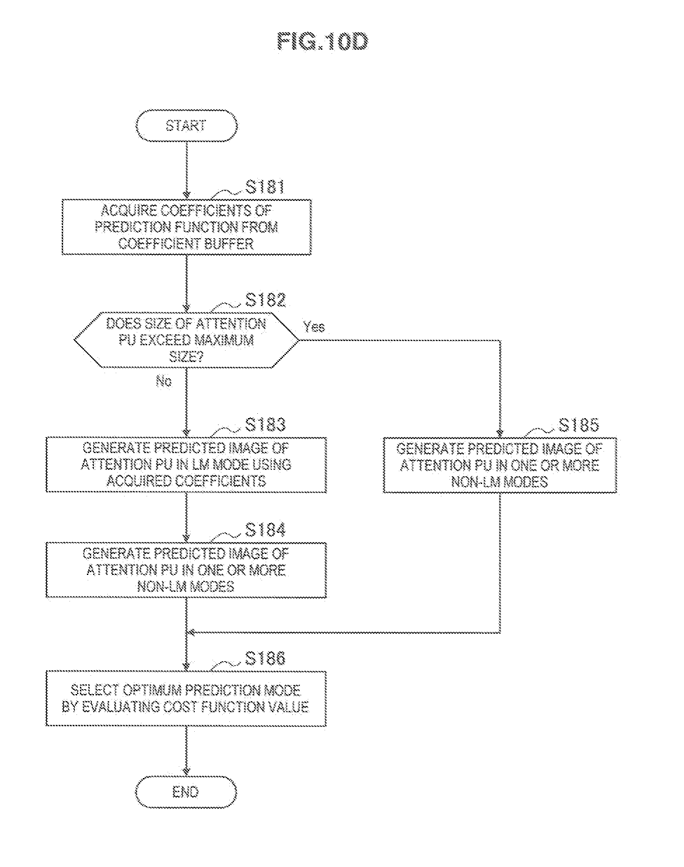

FIG. 10A is a flow chart showing an example of the flow of the intra prediction process for encoding performed in the upper layer according to the first technique when the LM mode is selected in the lower layer.

Referring to FIG. 10A, the coefficient acquisition section 42b first acquires coefficients of the prediction function in LM mode calculated for the prediction unit in the lower layer corresponding to the prediction unit to be predicted (hereinafter, called an attention PU) from the coefficient buffer in the common memory 2 (step S131).

Next, the prediction control section 41b determines whether the size of the attention PU exceeds the maximum size (for example, 16×16 pixels) in which the LM mode can be used (step S132). If the size of the attention PU does not exceed the maximum size, the process proceeds to step S133. On the other hand, if the size of the attention PU exceeds the maximum size, the process proceeds to step S134.

In step S133, the prediction section 45b generates a predicted image of the attention PU in LM mode using the prediction function having the coefficients acquired by the coefficient acquisition section 42b (step S133).

In step S134, the prediction control section 41b divides the attention PU into a plurality of sub-blocks (step S134). The number N of sub-blocks is determined based on the size of the attention PU and the maximum size. Then, the prediction section 45b generates each predicted image of N sub-blocks in LM mode using the prediction function having the coefficients acquired by the coefficient acquisition section 42b (step S135).

(4) Second Technique

FIG. 10B is a flow chart showing an example of the flow of the intra prediction process for encoding performed in the upper layer according to the second technique when the LM mode is selected in the lower layer.

Referring to FIG. 10B, the coefficient acquisition section 42b first acquires coefficients of the prediction function in LM mode calculated for the PU in the lower layer corresponding to the attention PU from the coefficient buffer in the common memory 2 (step S141).

Next, the prediction control section 41b determines whether the size of the attention PU exceeds the maximum size in which the LM mode can be used (step S142). If the size of the attention PU does not exceed the maximum size, the process proceeds to step S143. On the other hand, if the size of the attention PU exceeds the maximum size, the process proceeds to step S145.

In step S143, the prediction section 45b generates a predicted image of the attention PU in LM mode for a re-estimation using the prediction function having the coefficients acquired by the coefficient acquisition section 42b (step S143). The prediction section 45b also generates a predicted image of the attention PU according to each of one or more non-LM modes (step S144).

In step S145, the prediction control section 41b divides the attention PU into a plurality of sub-blocks (step S145). Then, the prediction section 45b generates each predicted image of N sub-blocks in LM mode using the prediction function having the coefficients acquired by the coefficient acquisition section 42b (step S146). The prediction section 45b also generates a predicted image of the attention PU according to each of one or more non-LM modes (step S147).

Next, the mode determination section 46b selects the optimum prediction mode for the attention PU by evaluating cost function values of a plurality of prediction modes including the LM mode (step S148).

(5) Third Technique

FIG. 10C is a flow chart showing an example of the flow of the intra prediction process for encoding performed in the upper layer according to the third technique when the LM mode is selected in the lower layer.

Referring to FIG. 10C, the coefficient acquisition section 42b first acquires coefficients of the prediction function in LM mode calculated for the PU in the lower layer corresponding to the attention PU (hereinafter, called an attention PU) from the coefficient buffer in the common memory 2 (step S171).

Next, the prediction control section 41b determines whether the size of the attention PU exceeds the maximum size in which the LM mode can be used (step S172). If the size of the attention PU does not exceed the maximum size, the process proceeds to step S173. On the other hand, if the size of the attention PU exceeds the maximum size, the process proceeds to step S174.

In step S173, the prediction section 45b generates a predicted image of the attention PU in LM mode using the prediction function having the coefficients acquired by the coefficient acquisition section 42b (step S173).

In step S174, the prediction section 45b generates a predicted image of the attention PU according to each of one or more non-LM modes (step S174). Next, the mode determination section 46b selects the optimum prediction mode for the attention PU by evaluating the cost function value (step S175).

(6) Fourth Technique

FIG. 10D is a flow chart showing an example of the flow of the intra prediction process for encoding performed in the upper layer according to the fourth technique when the LM mode is selected in the lower layer.

Referring to FIG. 10D, the coefficient acquisition section 42b first acquires coefficients of the prediction function in LM mode calculated for the PU in the lower layer corresponding to the attention PU (hereinafter, called an attention PU) from the coefficient buffer in the common memory 2 (step S181).

Next, the prediction control section 41b determines whether the size of the attention PU exceeds the maximum size in which the LM mode can be used (step S182). If the size of the attention PU does not exceed the maximum size, the process proceeds to step S183. On the other hand, if the size of the attention PU exceeds the maximum size, the process proceeds to step S185.

In step S183, the prediction section 45b generates a predicted image of the attention PU in LM mode for a re-estimation using the prediction function having the coefficients acquired by the coefficient acquisition section 42b (step S183). The prediction section 45b also generates a predicted image of the attention PU according to each of one or more non-LM modes (step S184).

In step S185, the prediction section 45b generates a predicted image of the attention PU according to each of one or more non-LM modes (step S185).

Next, the mode determination section 46b selects the optimum prediction mode for the attention PU by evaluating the cost function value (step S186).

### 4. Configuration Example of Decoding Section According to an Embodiment

### 4-1. Overall Configuration Example

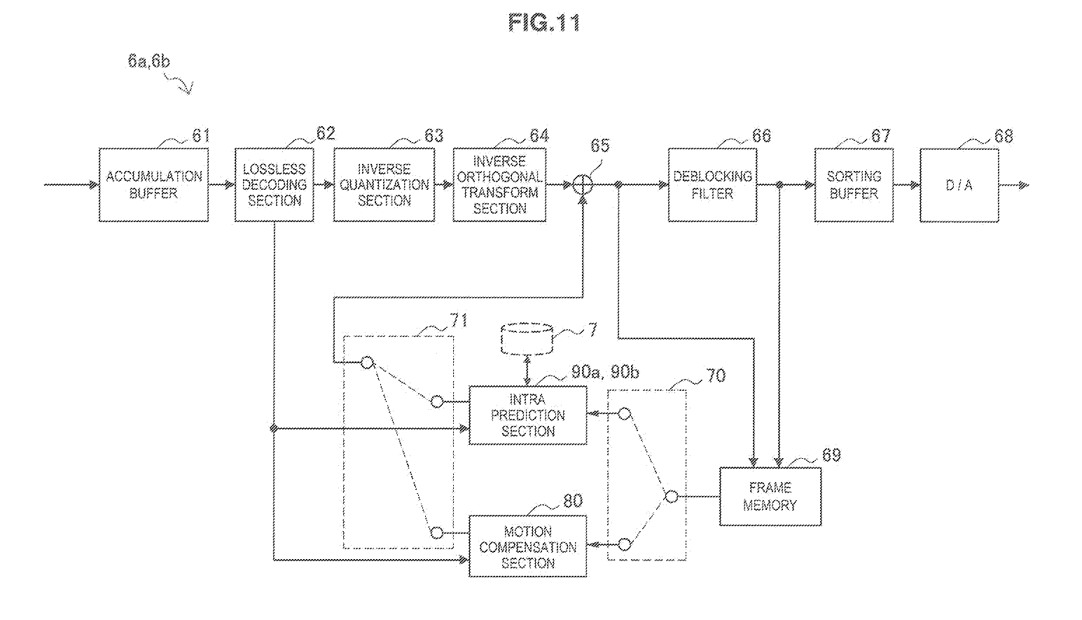

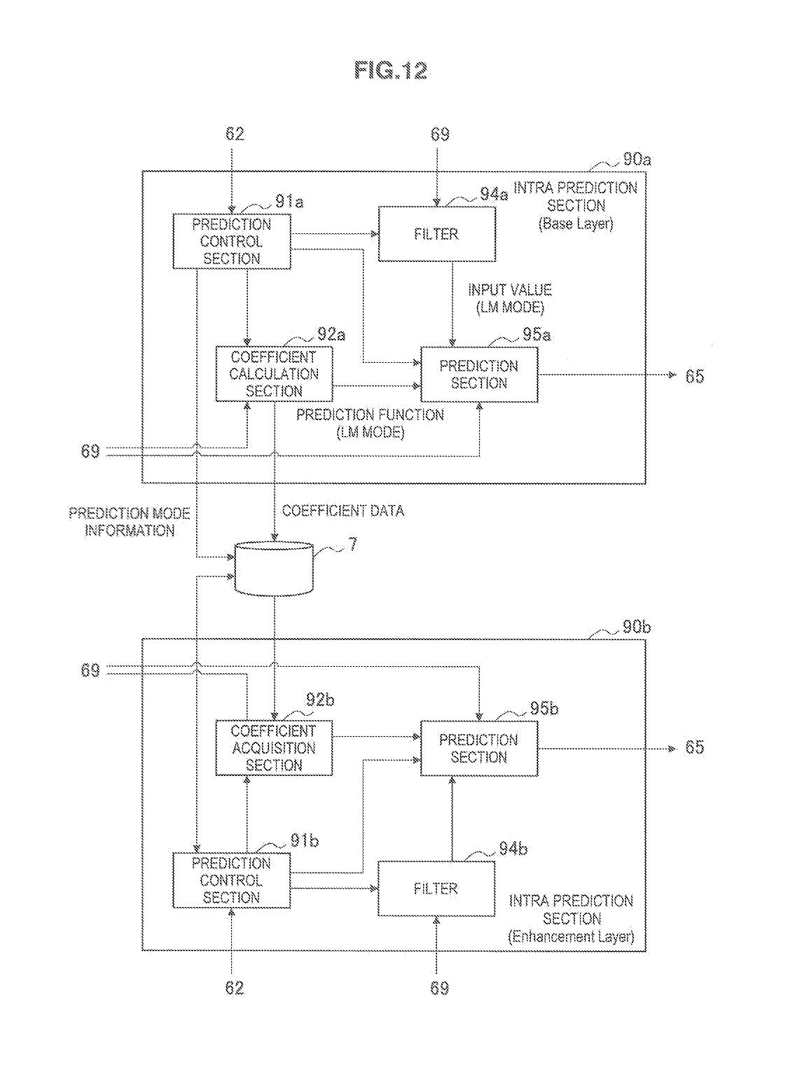

FIG. 11 is a block diagram showing an example of the configuration of the first decoding section 6a and the second decoding section 6b shown in FIG. 4. Referring to FIG. 11, the first decoding section 6a includes an accumulation buffer 61, a lossless decoding section 62, an inverse quantization section 63, an inverse orthogonal transform section 64, an addition section 65, a deblocking filter 66, a sorting buffer 67, a D/A (Digital to Analogue) conversion section 68, a frame memory 69, selectors 70, 71, a motion compensation section 80, and an intra prediction section 90a. The second decoding section 6b includes, instead of the intra prediction section 90a, an intra prediction section 90b.

The accumulation buffer 61 temporarily accumulates an encoded stream input via a transmission path using a storage medium.

The lossless decoding section 62 decodes an encoded stream of the base layer input from the accumulation buffer 61 according to the coding scheme used at the time of encoding. The lossless decoding section 62 also decodes information multiplexed in the header region of the encoded stream. The information decoded by the lossless decoding section 62 may contain, for example, the information about inter prediction and the information about intra prediction described above. The lossless decoding section 62 outputs the information about inter prediction to the motion compensation section 80. The lossless decoding section 62 also outputs the information about intra prediction to the intra prediction section 90a or 90b.

The inverse quantization section 63 inversely quantizes quantized data which has been decoded by the lossless decoding section 62. The inverse orthogonal transform section 64 generates predicted error data by performing inverse orthogonal transformation on transform coefficient data input from the inverse quantization section 63 according to the orthogonal transformation method used at the time of encoding. Then, the inverse orthogonal transform section 64 outputs the generated predicted error data to the addition section 65.

The addition section 65 adds the predicted error data input from the inverse orthogonal transform section 64 and predicted image data input from the selector 71 to thereby generate decoded image data. Then, the addition section 65 outputs the generated decoded image data to the deblocking filter 66 and the frame memory 69.

The deblocking filter 66 removes block distortion by filtering the decoded image data input from the addition section 65, and outputs the decoded image data after filtering to the sorting buffer 67 and the frame memory 69.

The sorting buffer 67 generates a series of image data in a time sequence by sorting images input from the deblocking filter 66. Then, the sorting buffer 67 outputs the generated image data to the D/A conversion section 68.

The D/A conversion section 68 converts the image data in a digital format input from the sorting buffer 67 into an image signal in an analogue format. Then, the D/A conversion section 68 causes an image to be displayed by outputting the analogue image signal to a display (not shown) connected to the image decoding device 60, for example.

The frame memory 69 stores, using a storage medium, the decoded image data before filtering input from the addition section 65, and the decoded image data after filtering input from the deblocking filter 66.

The selector 70 switches the output destination of the image data from the frame memory 62 between the motion compensation section 80 and the intra prediction section 90a or 90b for each block in the image according to mode information acquired by the lossless decoding section 62a or 62b. For example, in the case the inter prediction mode is specified, the selector 70 outputs the decoded image data after filtering that is supplied from the frame memory 69 to the motion compensation section 80 as the reference image data. Also, in the case the intra prediction mode is specified, the selector 70 outputs the decoded image data before filtering that is supplied from the frame memory 69 to the intra prediction section 90a or 90b as reference image data.

The selector 71 switches the output source of predicted image data to be supplied to the addition section 65 between the motion compensation section 80 and the intra prediction section 90a or 90b according to the mode information acquired by the lossless decoding section 62. For example, in the case the inter prediction mode is specified, the selector 71 supplies to the addition section 65 the predicted image data output from the motion compensation section 80. Also, in the case the intra prediction mode is specified, the selector 71 supplies to the addition section 65 the predicted image data output from the intra prediction section 90a or 90b.

The motion compensation section 80 performs a motion compensation process based on the information about inter prediction input from the lossless decoding section 62 and the reference image data from the frame memory 69, and generates predicted image data. Then, the motion compensation section 80 outputs the generated predicted image data to the selector 71.

The intra prediction section 90a performs an intra prediction process of the base layer based on the information about intra prediction input from the lossless decoding section 62 and the reference image data from the frame memory 69, and generates predicted image data. Then, the intra prediction section 90a outputs the generated predicted image data of the base layer to the selector 71. Also, the intra prediction section 40a causes the common memory 7 to buffer at least a portion of parameters about the intra prediction.

The intra prediction section 90b performs an intra prediction process of an enhancement layer based on the information about intra prediction input from the lossless decoding section 62 and the reference image data from the frame memory 69, and generates predicted image data. Then, the intra prediction section 90b outputs the generated predicted image data of the enhancement layer to the selector 71. Also, the intra prediction section 40b omits at least a portion of the intra prediction process of the enhancement layer by reusing parameters buffered by the common memory 7.

The first decoding section 6a performs a series of decoding processes described here on a sequence of image data of the base layer. The second decoding section 6b performs a series of decoding processes described here on a sequence of image data of the enhancement layer. When a plurality of enhancement layers is present, the decoding process of the enhancement layer can be repeated as many times as the number of enhancement layers. The decoding process of the base layer and that of an enhancement layer may be performed by being synchronized in the processing unit, for example, the decoding unit or the prediction unit.

### 4-2. Detailed Configuration of Intra Prediction Section

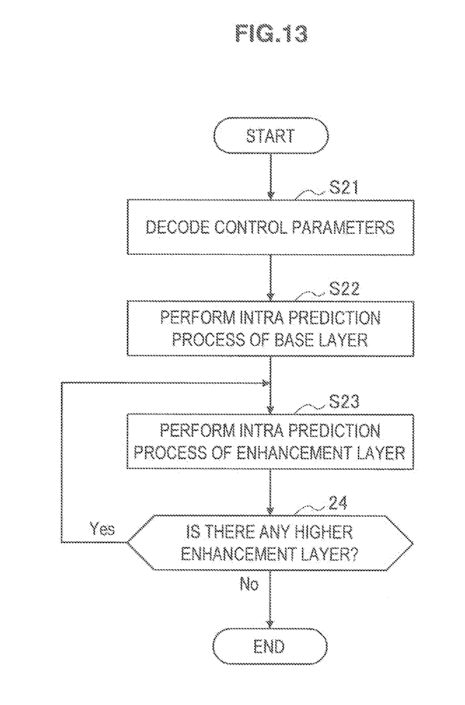

FIG. 12 is a block diagram showing an example of the detailed configuration of the intra prediction sections 90a. 90b shown in FIG. 11. Referring to FIG. 12, the intra prediction section 90a includes a prediction control section 91a, a coefficient calculation section 92a, a filter 94a, and a prediction section 95a. The intra prediction section 90b includes a prediction control section 91b, a coefficient acquisition section 92b, a filter 94b, and a prediction section 95b.

(1) Intra Prediction Process of the Base Layer

The prediction control section 91a of the intra prediction section 90a controls the intra prediction process of the base layer. For example, the prediction control section 91a performs the intra prediction process for the luminance component (Y) and the intra prediction process for the color difference component (Cb, Cr) for each prediction unit (PU). More specifically, the prediction control section 91a causes the prediction section 95a to generate a predicted image of each prediction unit according to the prediction mode indicated by the prediction mode information decoded by the lossless decoding section 62.

When the prediction mode information indicating the LM mode is decoded, the coefficient calculation section 92a calculates coefficients of a prediction function used in LM mode according to the above Formula (2) and Formula (3) with reference to reference pixels in neighboring blocks adjacent to the prediction unit to be predicted. The filter 94a generates an input value into the prediction function in LM mode by down-sampling (phase shifting) pixel values of the luminance component of the prediction unit to be predicted input from the frame memory 69 in accordance with the chroma format.

The prediction section 95a generates a predicted image of each prediction unit for each color component (that is, the luminance component and the color difference component) according to the prediction mode indicated by the prediction mode information under the control of the prediction control section 91a. When the prediction mode information indicating the LM mode is decoded, the prediction section 95a predicts the value of each color difference component by substituting an input value of the luminance component generated by the filter 94a into a prediction function having the coefficients calculated by the coefficient calculation section 92a. Intra predictions by the prediction section 95a in other prediction modes may be made in the same manner as existing techniques. The prediction section 95a outputs predicted image data generated as a result of prediction to the addition section 65.

The prediction control section 91a stores prediction mode information indicating the prediction mode for each prediction unit in the base layer in the mode information buffer provided in the common memory 7. The coefficient calculation section 92a stores calculated coefficient values of the prediction function in the coefficient buffer provided in the common memory 7 at least for each prediction unit for which the LM mode is specified.

(2) Intra Prediction Process of an Enhancement Layer

The prediction control section 91b of the intra prediction section 90b controls the intra prediction process of an enhancement layer. For example, the prediction control section 91b performs the intra prediction process for the luminance component (Y) and the intra prediction process for the color difference component (Cb, Cr) for each prediction unit (PU). More specifically, the prediction control section 91b causes the prediction section 95b to generate a predicted image of each prediction unit according to the prediction mode indicated by the prediction mode information decoded by the lossless decoding section 62 or the same prediction mode as that of the corresponding prediction unit in the lower layer.

The intra prediction process for the color difference component is controlled by the prediction control section 91b according to one of the aforementioned first to fourth techniques.

For example, in the first technique, when the prediction mode information indicates the LM mode for the first prediction unit in the lower layer, the prediction control section 91b causes the prediction section 95b to generate a predicted image in LM mode without acquiring new prediction mode information for the corresponding second prediction unit in the upper layer. More specifically, the coefficient acquisition section 92b acquires coefficients calculated for the first prediction unit from the common memory 7 under the control of the prediction control section 91b. The filter 94b generates an input value into the prediction function in LM mode by down-sampling pixel values of the luminance component in accordance with the chroma format. The prediction section 95b generates a predicted image of the second prediction unit in LM mode using the prediction function having the coefficients acquired by the coefficient acquisition section 92b.

If the spatial resolution of the color difference component or the density of the color different component in an upper layer is higher than in a lower layer (that is, space scalability or chroma format scalability is realized), an exceptional process is performed in accordance with the size of the second prediction unit. More specifically, when the size of the second prediction unit exceeds the maximum size in which the LM mode can be used, the prediction control section 91b divides the second prediction unit into a plurality of sub-blocks. Then, the prediction section 95b generates each predicted image of the plurality of sub-blocks in LM mode using the prediction function having the coefficients acquired by the coefficient acquisition section 92b.

In the second technique, when the prediction mode information indicates the LM mode for the first prediction unit in the lower layer, the prediction control section 91b acquires decoded new prediction mode information for the corresponding second prediction unit in the upper layer. Then, if the new prediction mode information also indicates the LM mode, the prediction control section 91b causes the prediction section 95b to generate a predicted image in LM mode. In this case, the prediction section 95b generates a predicted image of the second prediction unit in LM mode using the prediction function having the coefficients acquired by the coefficient acquisition section 92b from the common memory 2 and calculated for the first prediction unit.

If the size of the second prediction unit exceeds the maximum size and new prediction mode information also indicates the LM mode when the spatial resolution of the color difference component or the density of the color different component in the upper layer is higher than in the lower layer, the prediction control section 91b divides the second prediction unit into a plurality of sub-blocks. Then, the prediction section 95b generates each predicted image of the plurality of sub-blocks in LM mode using the prediction function having the coefficients acquired by the coefficient acquisition section 92b.

In the third technique, when the prediction mode information indicates the LM mode for the first prediction unit in the lower layer, the prediction control section 91b causes the prediction section 95b to generate a predicted image in LM mode also for the corresponding second prediction unit in the upper layer. The prediction section 95b generates a predicted image of the second prediction unit in LM mode using the prediction function having the coefficients acquired by the coefficient acquisition section 92b from the common memory 2 and calculated for the first prediction unit.

If the size of the second prediction unit exceeds the maximum size when the spatial resolution of the color difference component or the density of the color different component in the upper layer is higher than in the lower layer, the prediction control section 91b acquires decoded new prediction mode information. The new prediction mode information acquired here indicates any one prediction mode other than the LM mode. In this case, the prediction section 95b generates a predicted image of the second prediction unit according to the prediction mode indicated by the new prediction mode information.

In the fourth technique, the prediction control section 91b acquires decoded new prediction mode information for the second prediction unit in the upper layer corresponding to the first prediction unit in the lower layer. Then, if the new prediction mode information also indicates the LM mode, the prediction control section 91b causes the prediction section 95b to generate a predicted image in LM mode. In this case, the prediction section 95b generates a predicted image of the second prediction unit in LM mode using the prediction function having the coefficients acquired by the coefficient acquisition section 92b from the common memory 2 and calculated for the first prediction unit. When the size of the second prediction unit exceeds the maximum size, the new prediction mode information indicates any one prediction mode other than the LM mode.

If a higher enhancement layer remains regardless of the adopted technique, the prediction control section 91b stores prediction mode information indicating the prediction mode for each prediction unit in the mode information buffer provided in the common memory 7. Coefficients stored in the coefficient buffer in the common memory 7 can be retained until the intra prediction for all layers is completed.

### 5. Process Flow for Decoding According to an Embodiment

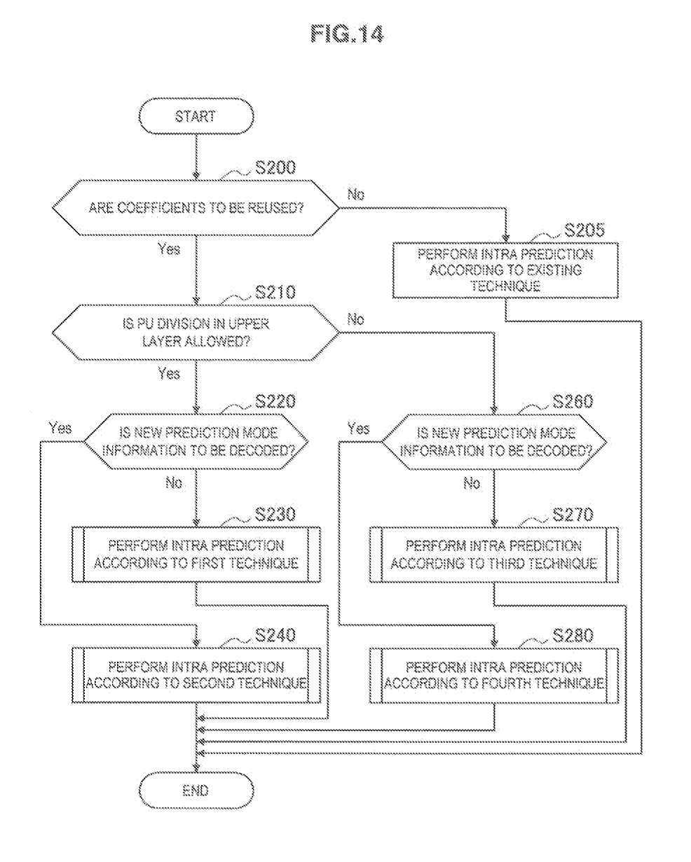

In this section, the process flow for decoding will be described using FIGS. 13 to 15D.

(1) Schematic Flow

FIG. 13 is a flow chart showing an example of the schematic process flow for decoding according to an embodiment.

Referring to FIG. 13, control parameters encoded inside an encoded stream are decoded by the lossless decoding section 62 (step S21). Control parameters decoded here may include any parameter such as the aforementioned coefficient reuse flag, mode fixing flag, and division flag and also prediction mode information. Decoding of parameters may be performed as part of the intra prediction process for each layer.

Next, the intra prediction section 90a for the base layer performs the intra prediction process of the base layer (step S22). The intra prediction process here may be processing according to specifications as defined in, for example, Non-Patent Literature 1 described above. Parameters reused between layers can be buffered by using the common memory 7.

Next, the intra prediction section 90b for an enhancement layer performs the intra prediction process of the enhancement layer (step S23). Parameters reused between layers can be reused by the intra prediction section 90b after being read from the common memory 7.

Next, when a plurality of enhancement layers is present, whether an upper enhancement layer that is not yet processed remains is determined (step S24). If an upper enhancement layer that is not yet processed remains, the intra prediction process in step S23 is repeated for the upper enhancement layer.

(2) Branching of the Intra Prediction Process

The image decoding device 60 may support only of the first to fourth techniques described above or a plurality of techniques of these techniques. When a plurality of techniques is supported, the prediction control section 91b of the intra prediction section 90b can determine for each process which technique to use to perform the intra prediction process of an enhancement layer. FIG. 14 illustrates such a determination of branching.

Referring to FIG. 14, the prediction control section 91b first determines whether to reuse coefficients of a prediction function in LM mode (step S200). This determination may be made based on conditions such as device settings or according to the aforementioned coefficient reuse flag that can be decoded from an encoded stream.

When coefficients of a prediction function in LM mode are not reused, the prediction control section 91b performs the intra prediction process of an enhancement layer according to an existing technique, instead of the first to fourth techniques described above (step S205).

When coefficients of a prediction function in LM mode are reused, the prediction control section 91b determines whether to allow the division of the prediction unit in the upper layer (step S210). This determination may be made according to the aforementioned division flag that can be decoded from an encoded stream. Further, when the LM mode is specified for the lower layer, the prediction control section 91b determines whether to decode new prediction mode information for the upper layer (steps S220, S260). This determination may be made according to the aforementioned mode fixing flag that can be decoded from an encoded stream.

When the division of the prediction unit is allowed and new prediction mode information is not decoded, the prediction control section 91b performs the intra prediction process of an enhancement layer according to the first technique described above (step S230).

When the division of the prediction unit is allowed and new prediction mode information is decoded, the prediction control section 91b performs the intra prediction process of an enhancement layer according to the second technique described above (step S240).

When the division of the prediction unit is not allowed and new prediction mode information is not decoded, the prediction control section 91b performs the intra prediction process of an enhancement layer according to the third technique described above (step S270).

When the division of the prediction unit is not allowed and new prediction mode information is decoded, the prediction control section 91b performs the intra prediction process of an enhancement layer according to the fourth technique described above (step S280).

(3) First Technique

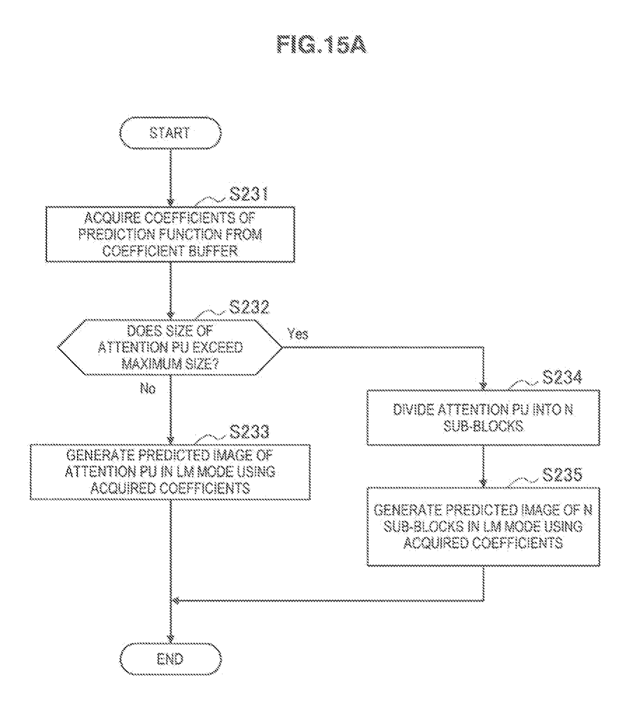

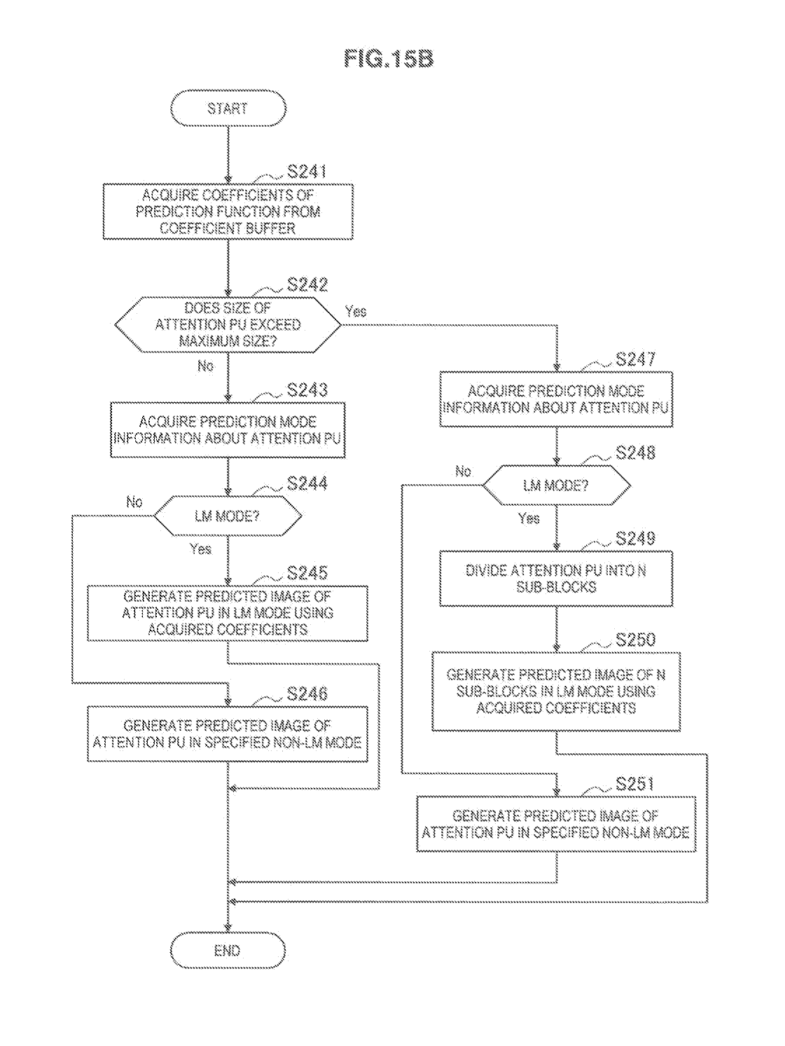

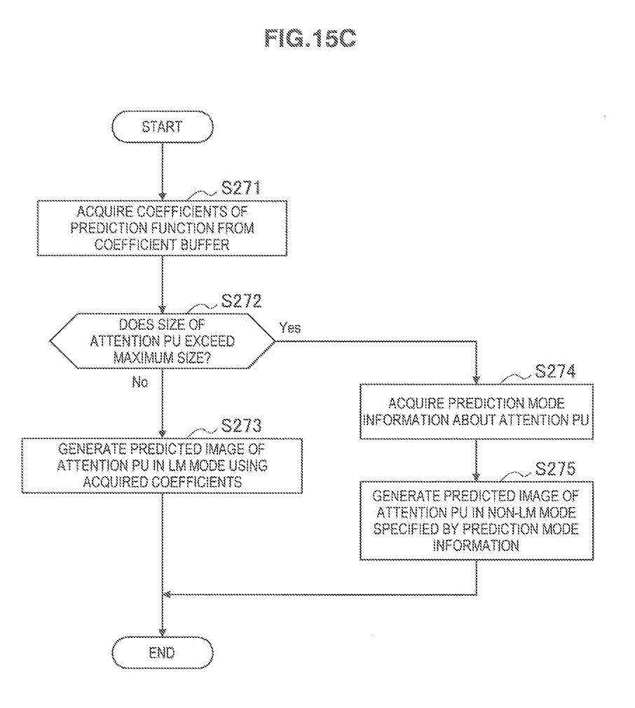

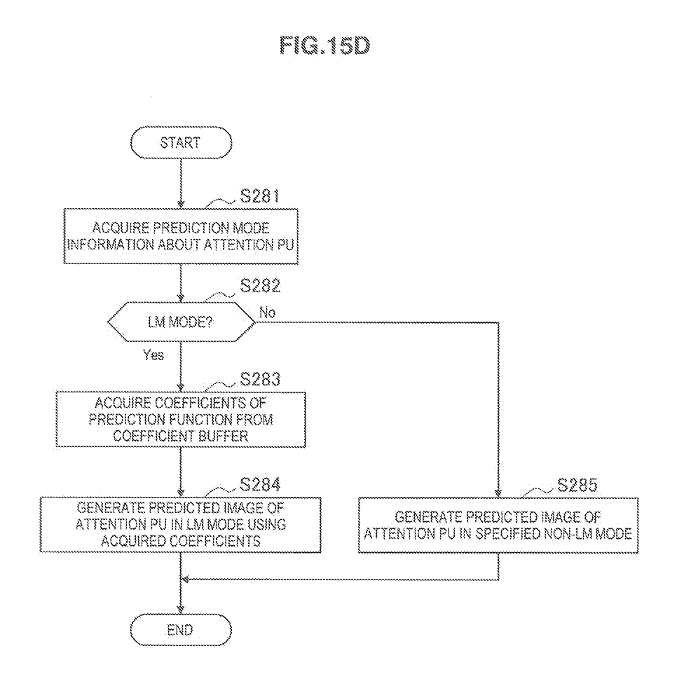

FIG. 15A is a flow chart showing an example of the flow of the intra prediction process for decoding performed in the upper layer according to the first technique when the LM mode is specified in the lower layer.

Referring to FIG. 15A, the coefficient acquisition section 92b first acquires coefficients of the prediction function in LM mode calculated for the prediction unit in the lower layer corresponding to the prediction unit to be predicted (hereinafter, called an attention PU) from the coefficient buffer in the common memory 7 (step S231).

Next, the prediction control section 91b determines whether the size of the attention PU exceeds the maximum size (for example, 16×16 pixels) in which the LM mode can be used (step S232). If the size of the attention PU does not exceed the maximum size, the process proceeds to step S233. On the other hand, if the size of the attention PU exceeds the maximum size, the process proceeds to step S234.

In step S233, the prediction section 95b generates a predicted image of the attention PU in LM mode using the prediction function having the coefficients acquired by the coefficient acquisition section 92b (step S233).

In step S234, the prediction control section 91b divides the attention PU into a plurality of sub-blocks (step S234). The number N of sub-blocks is determined based on the size of the attention PU and the maximum size. Then, the prediction section 95b generates each predicted image of N sub-blocks in LM mode using the prediction function having the coefficients acquired by the coefficient acquisition section 92b (step S235).

(4) Second Technique

FIG. 15B is a flow chart showing an example of the flow of the intra prediction process for decoding performed in the upper layer according to the second technique when the LM mode is specified in the lower layer.

Referring to FIG. 15B, the coefficient acquisition section 92b first acquires coefficients of the prediction function in LM mode calculated for the PU in the lower layer corresponding to the attention PU from the coefficient buffer in the common memory 7 (step S241).

Next, the prediction control section 91b determines whether the size of the attention PU exceeds the maximum size in which the LM mode can be used (step S242). If the size of the attention PU does not exceed the maximum size, the process proceeds to step S243. On the other hand, if the size of the attention PU exceeds the maximum size, the process proceeds to step S247.

In step S243, the prediction control section 91b acquires new prediction mode information decoded for the attention PU (step S243). If the new prediction mode information acquired here also indicates the LM mode (step S244), the prediction section 95b generates a predicted image of the attention PU in LM mode using the prediction function having the coefficients acquired by the coefficient acquisition section 92b (step S245). On the other hand, if the new prediction mode information indicates a non-LM mode, the prediction section 95b generates a predicted image of the attention PU in the specified non-LM mode (step S246).

In step S247, the prediction control section 91b acquires new prediction mode information decoded for the attention PU (step S247). If the new prediction mode information acquired here also indicates the LM mode (step S248), the prediction control section 91b divides the attention PU into a plurality of sub-blocks (step S249). Then, the prediction section 95b generates each predicted image of N sub-blocks in LM mode using the prediction function having the coefficients acquired by the coefficient acquisition section 92b (step S250). On the other hand, if the new prediction mode information indicates a non-LM mode, the prediction section 95b generates a predicted image of the attention PU in the specified non-LM mode (step S251).

(5) Third Technique

FIG. 15C is a flow chart showing an example of the flow of the intra prediction process for decoding performed in the upper layer according to the third technique when the LM mode is specified in the lower layer.

Referring to FIG. 15C, the coefficient acquisition section 92b first acquires coefficients of the prediction function in LM mode calculated for the PU in the lower layer corresponding to the attention PU from the coefficient buffer in the common memory 7 (step S271).

Next, the prediction control section 91b determines whether the size of the attention PU exceeds the maximum size in which the LM mode can be used (step S272). If the size of the attention PU does not exceed the maximum size, the process proceeds to step S273. On the other hand, if the size of the attention PU exceeds the maximum size, the process proceeds to step S274.

In step S273, the prediction section 95b generates a predicted image of the attention PU in LM mode using the prediction function having the coefficients acquired by the coefficient acquisition section 92b (step S273).

In step S274, the prediction control section 91b acquires new prediction mode information decoded for the attention PU (step S274). The new prediction mode information acquired here indicates any one non-LM mode. The prediction section 95b generates a predicted image of the attention PU in the specified non-LM mode (step S275).

(6) Fourth Technique

FIG. 15D is a flow chart showing an example of the flow of the intra prediction process for decoding performed in the upper layer according to the fourth technique when the LM mode is specified in the lower layer.

Referring to FIG. 15D, the prediction control section 91b acquires new prediction mode information decoded for the attention PU (step S281).

If the new prediction mode information acquired here also indicates the LM mode (step S282), the coefficient acquisition section 92b acquires coefficients of the prediction function in LM mode calculated for the PU in the lower layer corresponding to the attention PU from the coefficient buffer in the common memory 7 (step S283). Then, the prediction section 95b generates a predicted image of the attention PU in LM mode using the prediction function having the coefficients acquired by the coefficient acquisition section 92b (step S284).

On the other hand, if the new prediction mode information indicates a non-LM mode, the prediction section 95b generates a predicted image of the attention PU in the specified non-LM mode (step S285).

### 6. Example Application

### 6-1. Application to Various Products

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records images in a medium such as an optical disc, a magnetic disk or a flash memory, a reproduction device that reproduces images from such storage medium, and the like. Four example applications will be described below.

### (1) First Application Example

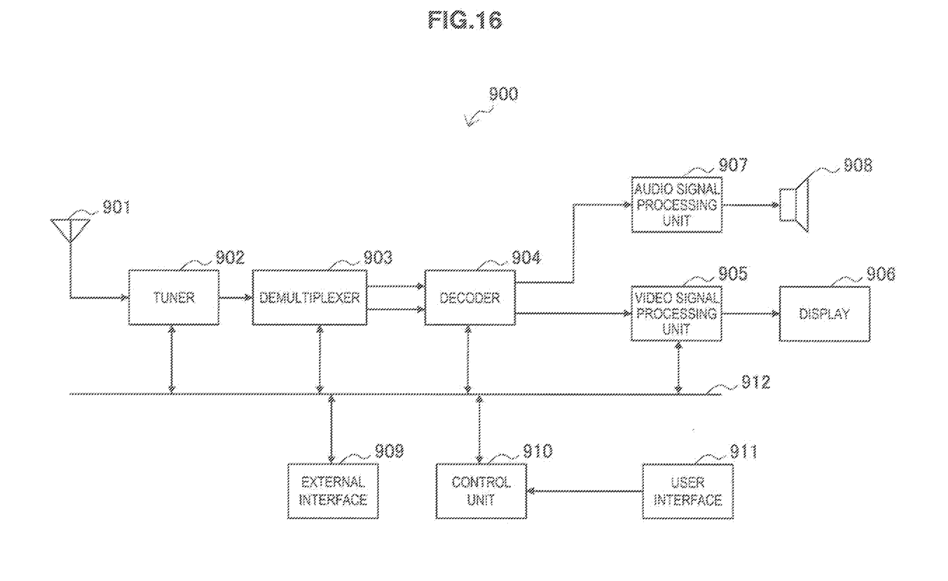

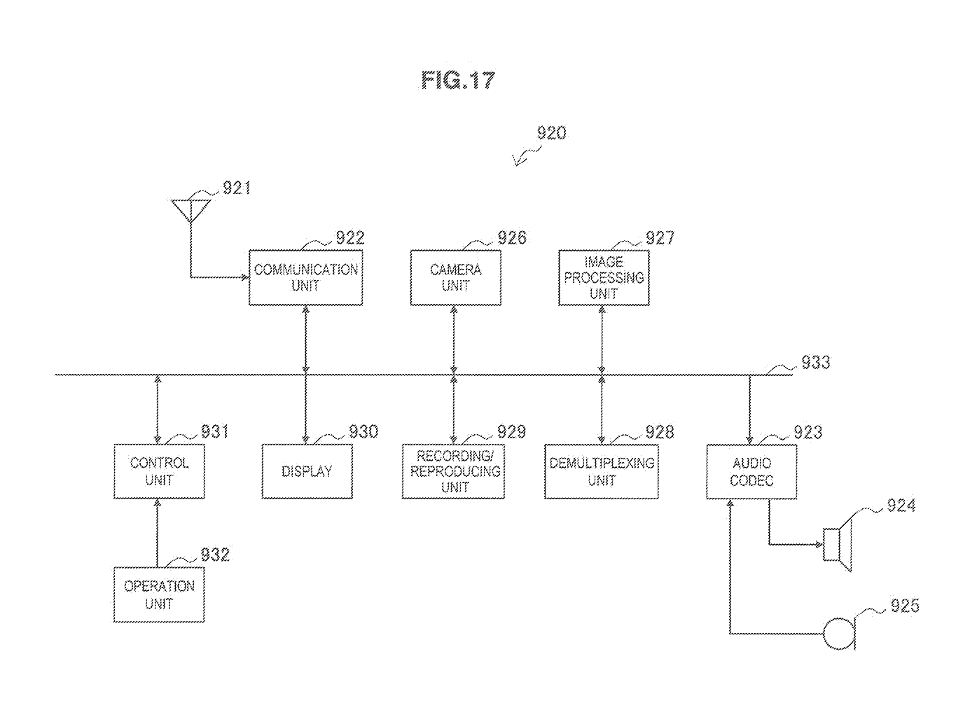

FIG. 16 is a diagram illustrating an example of a schematic configuration of a television device applying the aforementioned embodiment. A television device 900 includes an antenna 901, a tuner 902, a demultiplexer 903, a decoder 904, a video signal processing unit 905, a display 906, an audio signal processing unit 907, a speaker 908, an external interface 909, a control unit 910, a user interface 911, and a bus 912.

The tuner 902 extracts a signal of a desired channel from a broadcast signal received through the antenna 901 and demodulates the extracted signal. The tuner 902 then outputs an encoded bit stream obtained by the demodulation to the demultiplexer 903. That is, the tuner 902 has a role as transmission means receiving the encoded stream in which an image is encoded, in the television device 900.

The demultiplexer 903 isolates a video stream and an audio stream in a program to be viewed from the encoded bit stream and outputs each of the isolated streams to the decoder 904. The demultiplexer 903 also extracts auxiliary data such as an EPG (Electronic Program Guide) from the encoded bit stream and supplies the extracted data to the control unit 910. Here, the demultiplexer 903 may descramble the encoded bit stream when it is scrambled.

The decoder 904 decodes the video stream and the audio stream that are input from the demultiplexer 903. The decoder 904 then outputs video data generated by the decoding process to the video signal processing unit 905. Furthermore, the decoder 904 outputs audio data generated by the decoding process to the audio signal processing unit 907.

The video signal processing unit 905 reproduces the video data input from the decoder 904 and displays the video on the display 906. The video signal processing unit 905 may also display an application screen supplied through the network on the display 906. The video signal processing unit 905 may further perform an additional process such as noise reduction on the video data according to the setting. Furthermore, the video signal processing unit 905 may generate an image of a GUI (Graphical User Interface) such as a menu, a button, or a cursor and superpose the generated image onto the output image.

The display 906 is driven by a drive signal supplied from the video signal processing unit 905 and displays video or an image on a video screen of a display device (such as a liquid crystal display, a plasma display, or an OELD (Organic ElectroLuminescence Display)).

The audio signal processing unit 907 performs a reproducing process such as D/A conversion and amplification on the audio data input from the decoder 904 and outputs the audio from the speaker 908. The audio signal processing unit 907 may also perform an additional process such as noise reduction on the audio data.

The external interface 909 is an interface that connects the television device 900 with an external device or a network. For example, the decoder 904 may decode a video stream or an audio stream received through the external interface 909.

This means that the external interface 909 also has a role as the transmission means receiving the encoded stream in which an image is encoded, in the television device 900.

The control unit 910 includes a processor such as a CPU and a memory such as a RAM and a ROM. The memory stores a program executed by the CPU, program data, EPG data, and data acquired through the network. The program stored in the memory is read by the CPU at the start-up of the television device 900 and executed, for example. By executing the program, the CPU controls the operation of the television device 900 in accordance with an operation signal that is input from the user interface 911, for example.

The user interface 911 is connected to the control unit 910. The user interface 911 includes a button and a switch for a user to operate the television device 900 as well as a reception part which receives a remote control signal, for example. The user interface 911 detects a user operation through these components, generates the operation signal, and outputs the generated operation signal to the control unit 910.

The bus 912 mutually connects the tuner 902, the demultiplexer 903, the decoder 904, the video signal processing unit 905, the audio signal processing unit 907, the external interface 909, and the control unit 910.

The decoder 904 in the television device 900 configured in the aforementioned manner has a function of the image decoding device 60 according to the aforementioned embodiment. Accordingly, for scalable video decoding of images by the television device 900, the processing cost can be reduced by reusing coefficients of a prediction function in LM mode.

### (2) Second Application Example

FIG. 17 is a diagram illustrating an example of a schematic configuration of a mobile telephone applying the aforementioned embodiment. A mobile telephone 920 includes an antenna 921, a communication unit 922, an audio codec 923, a speaker 924, a microphone 925, a camera unit 926, an image processing unit 927, a demultiplexing unit 928, a recording/reproducing unit 929, a display 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 mutually connects the communication unit 922, the audio codec 923, the camera unit 926, the image processing unit 927, the demultiplexing unit 928, the recording/reproducing unit 929, the display 930, and the control unit 931.

The mobile telephone 920 performs an operation such as transmitting/receiving an audio signal, transmitting/receiving an electronic mail or image data, imaging an image, or recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A/D conversion on the converted audio data, and compresses the data. The audio codec 923 thereafter outputs the compressed audio data to the communication unit 922. The communication unit 922 encodes and modulates the audio data to generate a transmission signal. The communication unit 922 then transmits the generated transmission signal to a base station (not shown) through the antenna 921. Furthermore, the communication unit 922 amplifies a radio signal received through the antenna 921, converts a frequency of the signal, and acquires a reception signal. The communication unit 922 thereafter demodulates and decodes the reception signal to generate the audio data and output the generated audio data to the audio codec 923. The audio codec 923 expands the audio data, performs D/A conversion on the data, and generates the analog audio signal. The audio codec 923 then outputs the audio by supplying the generated audio signal to the speaker 924.

In the data communication mode, for example, the control unit 931 generates character data configuring an electronic mail, in accordance with a user operation through the operation unit 932. The control unit 931 further displays a character on the display 930. Moreover, the control unit 931 generates electronic mail data in accordance with a transmission instruction from a user through the operation unit 932 and outputs the generated electronic mail data to the communication unit 922. The communication unit 922 encodes and modulates the electronic mail data to generate a transmission signal. Then, the communication unit 922 transmits the generated transmission signal to the base station (not shown) through the antenna 921. The communication unit 922 further amplifies a radio signal received through the antenna 921, converts a frequency of the signal, and acquires a reception signal. The communication unit 922 thereafter demodulates and decodes the reception signal, restores the electronic mail data, and outputs the restored electronic mail data to the control unit 931. The control unit 931 displays the content of the electronic mail on the display 930 as well as stores the electronic mail data in a storage medium of the recording/reproducing unit 929.

The recording/reproducing unit 929 includes an arbitrary storage medium that is readable and writable. For example, the storage medium may be a built-in storage medium such as a RAM or a flash memory, or may be an externally-mounted storage medium such as a hard disk, a magnetic disk, a magneto-optical disk, an optical disk, a USB (Unallocated Space Bitmap) memory, or a memory card.

In the photography mode, for example, the camera unit 926 images an object, generates image data, and outputs the generated image data to the image processing unit 927. The image processing unit 927 encodes the image data input from the camera unit 926 and stores an encoded stream in the storage medium of the storing/reproducing unit 929.

In the videophone mode, for example, the demultiplexing unit 928 multiplexes a video stream encoded by the image processing unit 927 and an audio stream input from the audio codec 923, and outputs the multiplexed stream to the communication unit 922. The communication unit 922 encodes and modulates the stream to generate a transmission signal. The communication unit 922 subsequently transmits the generated transmission signal to the base station (not shown) through the antenna 921. Moreover, the communication unit 922 amplifies a radio signal received through the antenna 921, converts a frequency of the signal, and acquires a reception signal. The transmission signal and the reception signal can include an encoded bit stream. Then, the communication unit 922 demodulates and decodes the reception signal to restore the stream, and outputs the restored stream to the demultiplexing unit 928. The demultiplexing unit 928 isolates the video stream and the audio stream from the input stream and outputs the video stream and the audio stream to the image processing unit 927 and the audio codec 923, respectively. The image processing unit 927 decodes the video stream to generate video data. The video data is then supplied to the display 930, which displays a series of images. The audio codec 923 expands and performs D/A conversion on the audio stream to generate an analog audio signal. The audio codec 923 then supplies the generated audio signal to the speaker 924 to output the audio.

The image processing unit 927 in the mobile telephone 920 configured in the aforementioned manner has a function of the image encoding device 10 and the image decoding device 60 according to the aforementioned embodiment. Accordingly, for scalable video coding and decoding of images by the mobile telephone 920, the processing cost can be reduced by reusing coefficients of a prediction function in LM mode.

### (3) Third Application Example

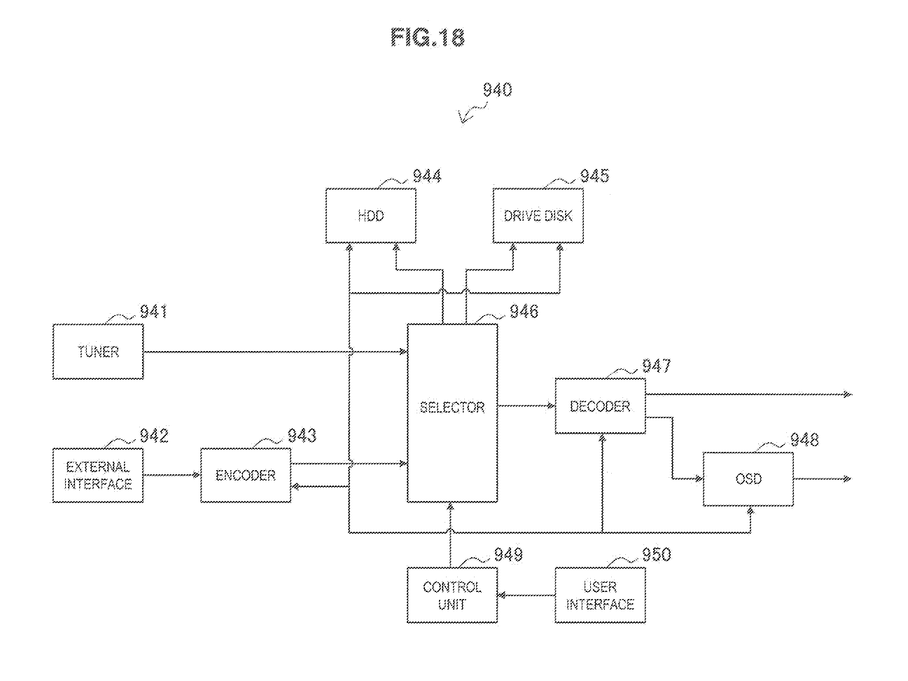

FIG. 18 is a diagram illustrating an example of a schematic configuration of a recording/reproducing device applying the aforementioned embodiment. A recording/reproducing device 940 encodes audio data and video data of a broadcast program received and records the data into a recording medium, for example. The recording/reproducing device 940 may also encode audio data and video data acquired from another device and record the data into the recording medium, for example. In response to a user instruction, for example, the recording/reproducing device 940 reproduces the data recorded in the recording medium on a monitor and a speaker. The recording/reproducing device 940 at this time decodes the audio data and the video data.

The recording/reproducing device 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from a broadcast signal received through an antenna (not shown) and demodulates the extracted signal. The tuner 941 then outputs an encoded bit stream obtained by the demodulation to the selector 946. That is, the tuner 941 has a role as transmission means in the recording/reproducing device 940.

The external interface 942 is an interface which connects the recording/reproducing device 940 with an external device or a network. The external interface 942 may be, for example, an IEEE 1394 interface, a network interface, a USB interface, or a flash memory interface. The video data and the audio data received through the external interface 942 are input to the encoder 943, for example. That is, the external interface 942 has a role as transmission means in the recording/reproducing device 940.

The encoder 943 encodes the video data and the audio data when the video data and the audio data input from the external interface 942 are not encoded. The encoder 943 thereafter outputs an encoded bit stream to the selector 946.

The HDD 944 records, into an internal hard disk, the encoded bit stream in which content data such as video and audio is compressed, various programs, and other data. The HDD 944 reads these data from the hard disk when reproducing the video and the audio.

The disk drive 945 records and reads data into/from a recording medium which is mounted to the disk drive. The recording medium mounted to the disk drive 945 may be, for example, a DVD disk (such as DVD-Video, DVD-RAM, DVD-R, DVD-RW, DVD+R, or DVD+RW) or a Blu-ray (Registered Trademark) disk.

The selector 946 selects the encoded bit stream input from the tuner 941 or the encoder 943 when recording the video and audio, and outputs the selected encoded bit stream to the HDD 944 or the disk drive 945. When reproducing the video and audio, on the other hand, the selector 946 outputs the encoded bit stream input from the HDD 944 or the disk drive 945 to the decoder 947.

The decoder 947 decodes the encoded bit stream to generate the video data and the audio data. The decoder 904 then outputs the generated video data to the OSD 948 and the generated audio data to an external speaker.

The OSD 948 reproduces the video data input from the decoder 947 and displays the video. The OSD 948 may also superpose an image of a GUI such as a menu, a button, or a cursor onto the video displayed.

The control unit 949 includes a processor such as a CPU and a memory such as a RAM and a ROM. The memory stores a program executed by the CPU as well as program data. The program stored in the memory is read by the CPU at the start-up of the recording/reproducing device 940 and executed, for example. By executing the program, the CPU controls the operation of the recording/reproducing device 940 in accordance with an operation signal that is input from the user interface 950, for example.

The user interface 950 is connected to the control unit 949. The user interface 950 includes a button and a switch for a user to operate the recording/reproducing device 940 as well as a reception part which receives a remote control signal, for example. The user interface 950 detects a user operation through these components, generates the operation signal, and outputs the generated operation signal to the control unit 949.

The encoder 943 in the recording/reproducing device 940 configured in the aforementioned manner has a function of the image encoding device 10 according to the aforementioned embodiment. On the other hand, the decoder 947 has a function of the image decoding device 60 according to the aforementioned embodiment. Accordingly, for scalable video coding and decoding of images by the recording/reproducing device 940, the processing cost can be reduced by reusing coefficients of a prediction function in LM mode.

### (4) Fourth Application Example

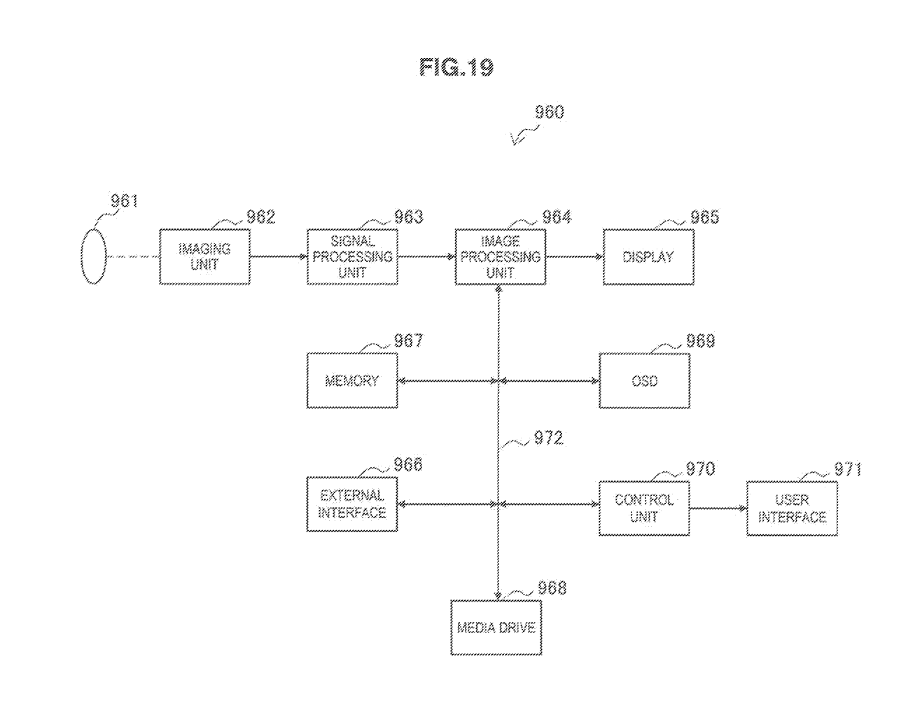

FIG. 19 shows an example of a schematic configuration of an image capturing device applying the aforementioned embodiment. An imaging device 960 images an object, generates an image, encodes image data, and records the data into a recording medium.

The imaging device 960 includes an optical block 961, an imaging unit 962, a signal processing unit 963, an image processing unit 964, a display 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display 965 is connected to the image processing unit 964. The user interface 971 is connected to the control unit 970. The bus 972 mutually connects the image processing unit 964, the external interface 966, the memory 967, the media drive 968, the OSD 969, and the control unit 970.

The optical block 961 includes a focus lens and a diaphragm mechanism. The optical block 961 forms an optical image of the object on an imaging surface of the imaging unit 962. The imaging unit 962 includes an image sensor such as a CCD (Charge Coupled Device) or a CMOS (Complementary Metal Oxide Semiconductor) and performs photoelectric conversion to convert the optical image formed on the imaging surface into an image signal as an electric signal. Subsequently, the imaging unit 962 outputs the image signal to the signal processing unit 963.

The signal processing unit 963 performs various camera signal processes such as a knee correction, a gamma correction and a color correction on the image signal input from the imaging unit 962. The signal processing unit 963 outputs the image data, on which the camera signal process has been performed, to the image processing unit 964.

The image processing unit 964 encodes the image data input from the signal processing unit 963 and generates the encoded data. The image processing unit 964 then outputs the generated encoded data to the external interface 966 or the media drive 968. The image processing unit 964 also decodes the encoded data input from the external interface 966 or the media drive 968 to generate image data. The image processing unit 964 then outputs the generated image data to the display 965. Moreover, the image processing unit 964 may output to the display 965 the image data input from the signal processing unit 963 to display the image. Furthermore, the image processing unit 964 may superpose display data acquired from the OSD 969 onto the image that is output on the display 965.

The OSD 969 generates an image of a GUI such as a menu, a button, or a cursor and outputs the generated image to the image processing unit 964.

The external interface 966 is configured as a USB input/output terminal, for example. The external interface 966 connects the imaging device 960 with a printer when printing an image, for example. Moreover, a drive is connected to the external interface 966 as needed. A removable medium such as a magnetic disk or an optical disk is mounted to the drive, for example, so that a program read from the removable medium can be installed to the imaging device 960. The external interface 966 may also be configured as a network interface that is connected to a network such as a LAN or the Internet. That is, the external interface 966 has a role as transmission means in the imaging device 960.

The recording medium mounted to the media drive 968 may be an arbitrary removable medium that is readable and writable such as a magnetic disk, a magneto-optical disk, an optical disk, or a semiconductor memory. Furthermore, the recording medium may be fixedly mounted to the media drive 968 so that a non-transportable storage unit such as a built-in hard disk drive or an SSD (Solid State Drive) is configured, for example.

The control unit 970 includes a processor such as a CPU and a memory such as a RAM and a ROM. The memory stores a program executed by the CPU as well as program data. The program stored in the memory is read by the CPU at the start-up of the imaging device 960 and then executed. By executing the program, the CPU controls the operation of the imaging device 960 in accordance with an operation signal that is input from the user interface 971, for example.

The user interface 971 is connected to the control unit 970. The user interface 971 includes a button and a switch for a user to operate the imaging device 960, for example. The user interface 971 detects a user operation through these components, generates the operation signal, and outputs the generated operation signal to the control unit 970.

The image processing unit 964 in the imaging device 960 configured in the aforementioned manner has a function of the image encoding device 10 and the image decoding device 60 according to the aforementioned embodiment. Accordingly, for scalable video coding and decoding of images by the imaging device 960, the processing cost can be reduced by reusing coefficients of a prediction function in LM mode.

### 6-2. Various Uses of Scalable Video Coding

Advantages of scalable video coding described above can be enjoyed in various uses. Three examples of use will be described below.

### (1) First Example

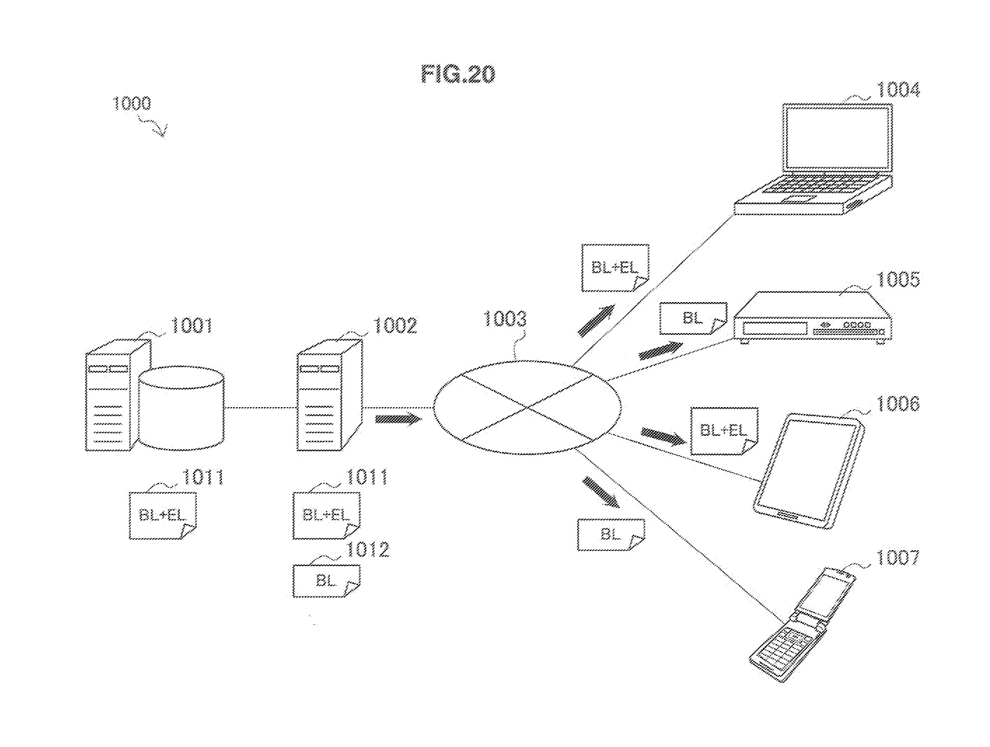

In the first example, scalable video coding is used for selective transmission of data. Referring to FIG. 20, a data transmission system 1000 includes a stream storage device 1001 and a delivery server 1002. The delivery server 1002 is connected to some terminal devices via a network 1003. The network 1003 may be a wire network or a wireless network or a combination thereof. FIG. 20 shows a PC (Personal Computer) 1004, an AV device 1005, a tablet device 1006, and a mobile phone 1007 as examples of the terminal devices.

The stream storage device 1001 stores, for example, stream data 1011 including a multiplexed stream generated by the image encoding device 10. The multiplexed stream includes an encoded stream of the base layer (BL) and an encoded stream of an enhancement layer (EL). The delivery server 1002 reads the stream data 1011 stored in the stream storage device 1001 and delivers at least a portion of the read stream data 1011 to the PC 1004, the AV device 1005, the tablet device 1006, and the mobile phone 1007 via the network 1003.

When a stream is delivered to a terminal device, the delivery server 1002 selects the stream to be delivered based on some condition such as capabilities of a terminal device or the communication environment. For example, the delivery server 1002 may avoid a delay in a terminal device or an occurrence of overflow or overload of a processor by not delivering an encoded stream having high image quality exceeding image quality that can be handled by the terminal device. The delivery server 1002 may also avoid occupation of communication bands of the network 1003 by not delivering an encoded stream having high image quality. On the other hand, when there is no risk to be avoided or it is considered to be appropriate based on a user's contract or some condition, the delivery server 1002 may deliver an entire multiplexed stream to a terminal device.

In the example of FIG. 20, the delivery server 1002 reads the stream data 1011 from the stream storage device 1001. Then, the delivery server 1002 delivers the stream data 1011 directly to the PC 1004 having high processing capabilities. Because the AV device 1005 has low processing capabilities, the delivery server 1002 generates stream data 1012 containing only an encoded stream of the base layer extracted from the stream data 1011 and delivers the stream data 1012 to the AV device 1005. The delivery server 1002 delivers the stream data 1011 directly to the tablet device 1006 capable of communication at a high communication rate. Because the mobile phone 1007 can communicate at a low communication rate, the delivery server 1002 delivers the stream data 1012 containing only an encoded stream of the base layer to the mobile phone 1007.

By using the multiplexed stream in this manner, the amount of traffic to be transmitted can adaptively be adjusted. The code amount of the stream data 1011 is reduced when compared with a case when each layer is individually encoded and thus, even if the whole stream data 1011 is delivered, the load on the network 1003 can be lessened. Further, memory resources of the stream storage device 1001 are saved.

Hardware performance of the terminal devices is different from device to device. In addition, capabilities of applications run on the terminal devices are diverse. Further, communication capacities of the network 1003 are varied. Capacities available for data transmission may change every moment due to other traffic. Thus, before starting delivery of stream data, the delivery server 1002 may acquire terminal information about hardware performance and application capabilities of terminal devices and network information about communication capacities of the network 1003 through signaling with the delivery destination terminal device. Then, the delivery server 1002 can select the stream to be delivered based on the acquired information.

Incidentally, the layer to be decoded may be extracted by the terminal device. For example, the PC 1004 may display a base layer image extracted and decoded from a received multiplexed stream on the screen thereof. After generating the stream data 1012 by extracting an encoded stream of the base layer from a received multiplexed stream, the PC 1004 may cause a storage medium to store the stream data 1012 or transfer the stream data to another device.

The configuration of the data transmission system 1000 shown in FIG. 20 is only an example. The data transmission system 1000 may include any numbers of the stream storage device 1001, the delivery server 1002, the network 1003, and terminal devices.

### (2) Second Example

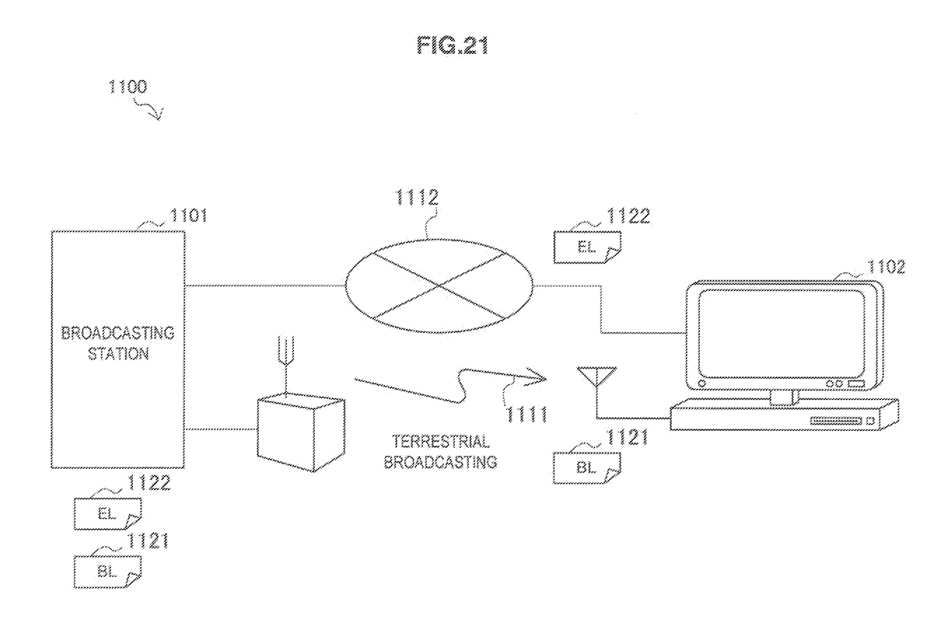

In the second example, scalable video coding is used for transmission of data via a plurality of communication channels. Referring to FIG. 21, a data transmission system 1100 includes a broadcasting station 1101 and a terminal device 1102. The broadcasting station 1101 broadcasts an encoded stream 1121 of the base layer on a terrestrial channel 1111. The broadcasting station 1101 also broadcasts an encoded stream 1122 of an enhancement layer to the terminal device 1102 via a network 1112.

The terminal device 1102 has a receiving function to receive terrestrial broadcasting broadcast by the broadcasting station 1101 and receives the encoded stream 1121 of the base layer via the terrestrial channel 1111. The terminal device 1102 also has a communication function to communicate with the broadcasting station 1101 and receives the encoded stream 1122 of an enhancement layer via the network 1112.

After receiving the encoded stream 1121 of the base layer, for example, in response to user's instructions, the terminal device 1102 may decode a base layer image from the received encoded stream 1121 and display the base layer image on the screen. Alternatively, the terminal device 1102 may cause a storage medium to store the decoded base layer image or transfer the base layer image to another device.

After receiving the encoded stream 1122 of an enhancement layer via the network 1112, for example, in response to user's instructions, the terminal device 1102 may generate a multiplexed stream by multiplexing the encoded stream 1121 of the base layer and the encoded stream 1122 of an enhancement layer. The terminal device 1102 may also decode an enhancement image from the encoded stream 1122 of an enhancement layer to display the enhancement image on the screen. Alternatively, the terminal device 1102 may cause a storage medium to store the decoded enhancement layer image or transfer the enhancement layer image to another device.

As described above, an encoded stream of each layer contained in a multiplexed stream can be transmitted via a different communication channel for each layer. Accordingly, a communication delay or an occurrence of overflow can be reduced by distributing loads on individual channels.

The communication channel to be used for transmission may dynamically be selected in accordance with some condition. For example, the encoded stream 1121 of the base layer whose data amount is relatively large may be transmitted via a communication channel having a wider bandwidth and the encoded stream 1122 of an enhancement layer whose data amount is relatively small may be transmitted via a communication channel having a narrower bandwidth. The communication channel on which the encoded stream 1122 of a specific layer is transmitted may be switched in accordance with the bandwidth of the communication channel. Accordingly, the load on individual channels can be lessened more effectively.

The configuration of the data transmission system 1100 shown in FIG. 21 is only an example. The data transmission system 1100 may include any numbers of communication channels and terminal devices. The configuration of the system described here may also be applied to other uses than broadcasting.

### (3) Third Example

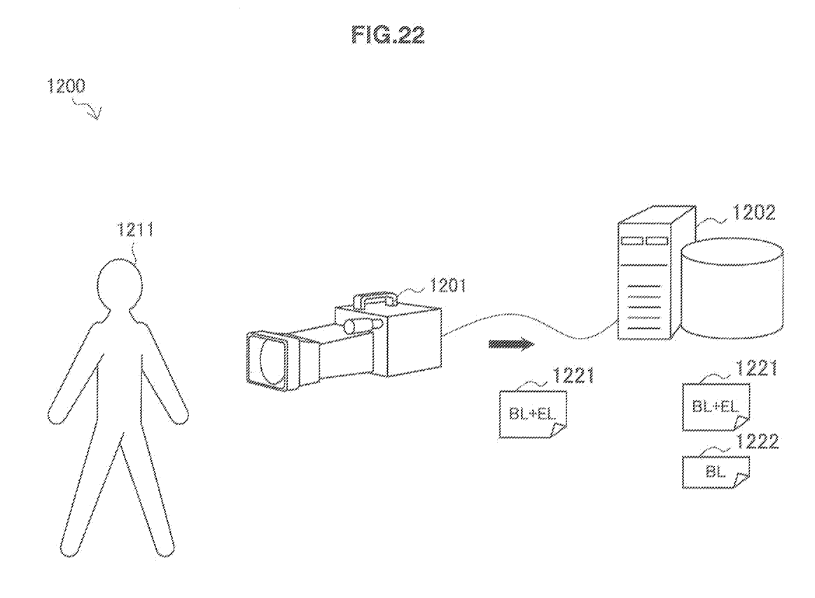

In the third example, scalable video coding is used for storage of video. Referring to FIG. 22, a data transmission system 1200 includes an imaging device 1201 and a stream storage device 1202. The imaging device 1201 scalable-encodes image data generated by a subject 1211 being imaged to generate a multiplexed stream 1221. The multiplexed stream 1221 includes an encoded stream of the base layer and an encoded stream of an enhancement layer. Then, the imaging device 1201 supplies the multiplexed stream 1221 to the stream storage device 1202.

The stream storage device 1202 stores the multiplexed stream 1221 supplied from the imaging device 1201 in different image quality for each mode. For example, the stream storage device 1202 extracts the encoded stream 1222 of the base layer from the multiplexed stream 1221 in normal mode and stores the extracted encoded stream 1222 of the base layer. In high quality mode, by contrast, the stream storage device 1202 stores the multiplexed stream 1221 as it is. Accordingly, the stream storage device 1202 can store a high-quality stream with a large amount of data only when recording of video in high quality is desired. Therefore, memory resources can be saved while the influence of image degradation on users is curbed.

For example, the imaging device 1201 is assumed to be a surveillance camera. When no surveillance object (for example, no intruder) appears in a captured image, the normal mode is selected. In this case, the captured image is likely to be unimportant and priority is given to the reduction of the amount of data so that the video is recorded in low image quality (that is, only the encoded stream 1222 of the base layer is stored). In contract, when a surveillance object (for example, the subject 1211 as an intruder) appears in a captured image, the high-quality mode is selected. In this case, the captured image is likely to be important and priority is given to high image quality so that the video is recorded in high image quality (that is, the multiplexed stream 1221 is stored).

In the example of FIG. 22, the mode is selected by the stream storage device 1202 based on, for example, an image analysis result. However, the present embodiment is not limited to such an example and the imaging device 1201 may select the mode. In the latter case, imaging device 1201 may supply the encoded stream 1222 of the base layer to the stream storage device 1202 in normal mode and the multiplexed stream 1221 to the stream storage device 1202 in high-quality mode.

Selection criteria for selecting the mode may be any criteria. For example, the mode may be switched in accordance with the loudness of voice acquired through a microphone or the waveform of voice. The mode may also be switched periodically. Also, the mode may be switched in response to user's instructions. Further, the number of selectable modes may be any number as long as the number of hierarchized layers is not exceeded.

The configuration of the data transmission system 1200 shown in FIG. 22 is only an example. The data transmission system 1200 may include any number of the imaging device 1201. The configuration of the system described here may also be applied to other uses than the surveillance camera.

### 6-3. Others

(1) Application to the Multi-View Codec

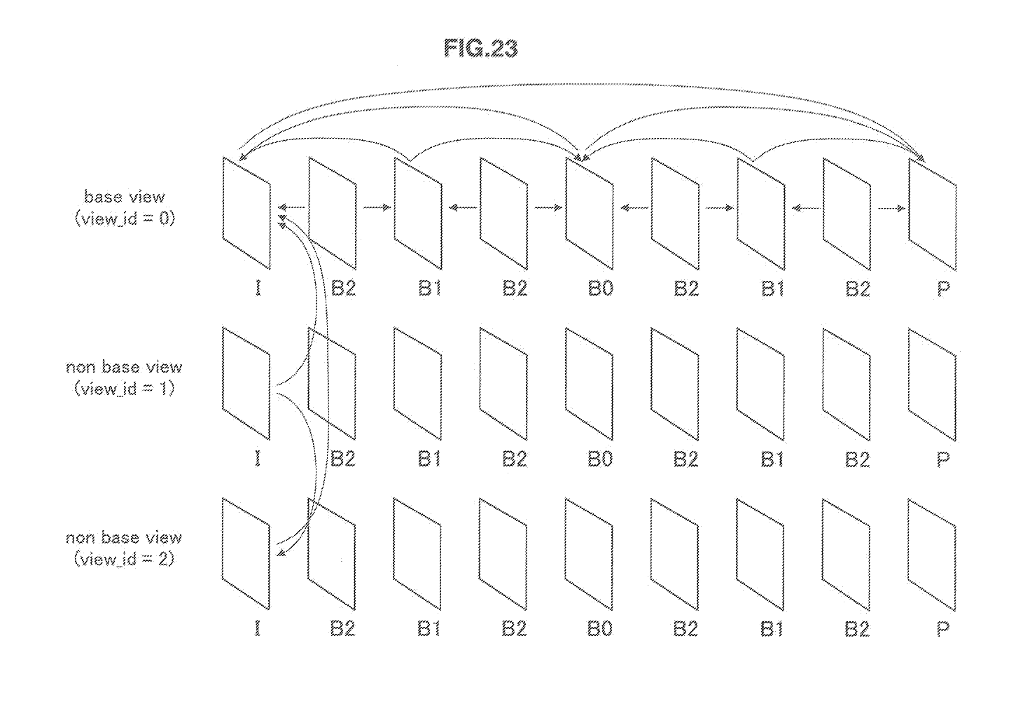

The multi-view codec is a kind of multi-layer codec and is an image encoding system to encode and decode so-called multi-view video. FIG. 23 is an explanatory view illustrating a multi-view codec. Referring to FIG. 23, sequences of three view frames captured from three viewpoints are shown. A view ID (view_id) is attached to each view. Among a plurality of these views, one view is specified as the base view. Views other than the base view are called non-base views. In the example of FIG. 23, the view whose view ID is “0” is the base view and two views whose view ID is “1” or “2” are non-base views. When these views are hierarchically encoded, each view may correspond to a layer. As indicated by arrows in FIG. 23, an image of a non-base view is encoded and decoded by referring to an image of the base view (an image of the other non-base view may also be referred to).

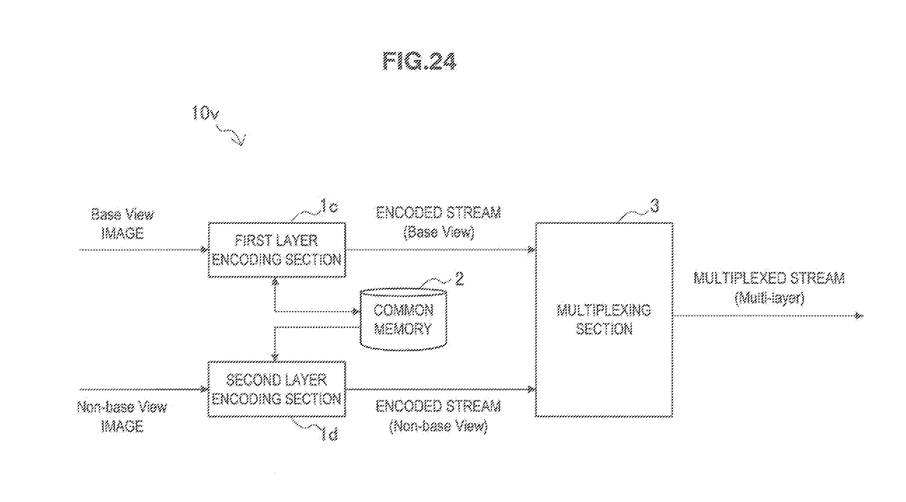

FIG. 24 is a block diagram showing a schematic configuration of an image encoding device 10v supporting the multi-view codec. Referring to FIG. 24, the image encoding device 10v includes a first layer encoding section Ic, a second layer encoding section 1d, the common memory 2, and the multiplexing section 3.

The function of the first layer encoding section Ic is the same as that of the first encoding section 1a described using FIG. 3 except that, instead of a base layer image, a base view image is received as input. The first layer encoding section Ic encodes the base view image to generate an encoded stream of a first layer. The function of the second layer encoding section 1d is the same as that of the second encoding section 1b described using FIG. 3 except that, instead of an enhancement layer image, a non-base view image is received as input. The second layer encoding section 1d encodes the non-base view image to generate an encoded stream of a second layer. The common memory 2 stores information commonly used between layers. The multiplexing section 3 multiplexes an encoded stream of the first layer generated by the first layer encoding section Ic and an encoded stream of the second layer generated by the second layer encoding section 1d to generate a multilayer multiplexed stream.

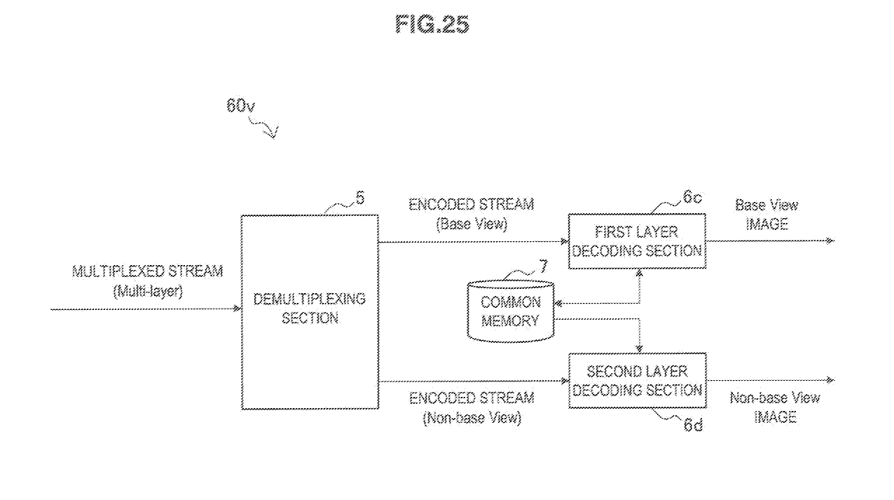

FIG. 25 is a block diagram showing a schematic configuration of an image decoding device 60v supporting the multi-view codec. Referring to FIG. 25, the image decoding device 60v includes the demultiplexing section 5, a first layer decoding section 6c, a second layer decoding section 6d, and the common memory 7.

The demultiplexing section 5 demultiplexes a multilayer multiplexed stream into an encoded stream of the first layer and an encoded stream of the second layer. The function of the first layer decoding section 6c is the same as that of the first decoding section 6a described using FIG. 4 except that an encoded stream in which, instead of a base layer image, a base view image is encoded is received as input. The first layer decoding section 6c decodes a base view image from an encoded stream of the first layer. The function of the second layer decoding section 6d is the same as that of the second decoding section 6b described using FIG. 4 except that an encoded stream in which, instead of an enhancement layer image, a non-base view image is encoded is received as input. The second layer decoding section 6d decodes a non-base view image from an encoded stream of the second layer. The common memory 7 stores information commonly used between layers.

When multi-view image data is encoded or decoded, the processing cost needed for processes in LM mode may be reduced according to technology in the present disclosure.

(2) Application to Streaming Technology

Technology in the present disclosure may also be applied to a streaming protocol. In MPEG-DASH (Dynamic Adaptive Streaming over HTTP), for example, a plurality of encoded streams having mutually different parameters such as the resolution is prepared by a stream server in advance. Then, the streaming server dynamically selects appropriate data for streaming from the plurality of encoded streams and delivers the selected data. In such a streaming protocol, the processing cost needed for processes in LM mode may be reduced according to technology in the present disclosure.

### 7. Summary

Heretofore, the image encoding device 10 and the image decoding device 60 according to an embodiment have been described using FIGS. 1 to 25. According to the above embodiment, coefficients of a prediction function in LM mode calculated in the base layer for encoding or decoding images in scalable video coding can be reused for an enhancement layer. Accordingly, a coefficient calculation process needing a lot of processing cost when compared with operations in other modes is omitted for an enhancement layer and therefore, performance degradation when the LM mode is adopted for scalable video coding can be avoided. When the LM mode is selected as the optimum intra prediction mode for a prediction unit in the lower layer, a prediction function having the coefficients calculated there may be said to represent the correlation between the luminance component and the color difference component in the prediction unit satisfactorily. Because such a prediction function is reused for the corresponding prediction unit in the upper layer, the processing cost can be reduced and at the same time, the prediction precision of the intra prediction in the enhancement layer can be maintained at a high level.

According to the first or third technique described above, when the LM mode is selected for the first prediction unit in the base layer, the LM mode is also applied to the corresponding second prediction unit in an enhancement layer without the prediction mode being re-estimated. In this case, prediction mode information is not encoded for the enhancement layer and therefore, encoding efficiency of an encoded stream of the enhancement layer can be improved. In addition, the re-estimation for the prediction mode is omitted on the encoder side and therefore, the processing cost of the intra prediction on the encoder side can significantly be reduced.

According to the first or second technique described above, when the size of the prediction unit in an enhancement layer exceeds the maximum size in which the LM mode can be used, the prediction unit is divided into a plurality of sub-blocks and the LM mode is applied to each sub-block. Thus, a predicted image can be generated in LM mode in an enhancement layer regardless of the size of the prediction unit of the base layer without extending a processing module of the LM mode so that a larger block size is supported. Therefore, benefits of the reduction of processing cost due to the reuse of coefficients can be enjoyed more widely while the prediction precision of the LM mode being maintained at a high level.

According to the second or fourth technique described above, even if the LM mode is selected in the base layer, a re-estimation of the prediction mode is performed for the prediction unit in an enhancement layer and new prediction mode information is encoded. Therefore, when a better prediction mode other than the LM mode is available in an enhancement layer, the prediction precision can further be improved by adopting the better prediction mode.

Mainly described herein is the example where the various pieces of information such as the information related to intra prediction and the information related to inter prediction are multiplexed to the header of the encoded stream and transmitted from the encoding side to the decoding side. The method of transmitting these pieces of information however is not limited to such example. For example, these pieces of information may be transmitted or recorded as separate data associated with the encoded bit stream without being multiplexed to the encoded bit stream. Here, the term “association” means to allow the image included in the bit stream (may be a part of the image such as a slice or a block) and the information corresponding to the current image to establish a link when decoding. Namely, the information may be transmitted on a different transmission path from the image (or the bit stream). The information may also be recorded in a different recording medium (or a different recording area in the same recording medium) from the image (or the bit stream). Furthermore, the information and the image (or the bit stream) may be associated with each other by an arbitrary unit such as a plurality of frames, one frame, or a portion within a frame.

The preferred embodiments of the present disclosure have been described above with reference to the accompanying drawings, whilst the present disclosure is not limited to the above examples, of course. A person skilled in the art may find various alternations and modifications within the scope of the appended claims, and it should be understood that they will naturally come under the technical scope of the present disclosure.

Additionally, the present technology may also be configured as below.

(1)

An image processing apparatus including:

a base layer prediction section that acquires prediction mode information for an intra prediction of a first prediction unit of a color difference component in a base layer of an image to be scalable-decoded; and

an enhancement layer prediction section that, when the prediction mode information acquired by the base layer prediction section indicates a luminance based color difference prediction mode, generates a predicted image in the luminance based color difference prediction mode for a second prediction unit of the color difference component corresponding to the first prediction unit in an enhancement layer using coefficients calculated for the first prediction unit.

(2)

The image processing apparatus according to (1), wherein, when the prediction mode information indicates the luminance based color difference prediction mode, the enhancement layer prediction unit generates the predicted image in the luminance based color difference prediction mode using the coefficients without acquiring new prediction mode information for the second prediction unit.

(3)

The image processing apparatus according to (2),

wherein a spatial resolution or a density of the color difference component in the enhancement layer is higher than in the base layer, and

wherein, when a size of the second prediction unit exceeds a maximum size in which the luminance based color difference prediction mode is used, the enhancement layer prediction unit divides the second prediction unit into a plurality of sub-blocks and generates the predicted image by applying the luminance based color difference prediction mode to each of the plurality of sub-blocks using the coefficients.

(4)

The image processing apparatus according to (1), wherein, when the prediction mode information indicates the luminance based color difference prediction mode and also newly acquired prediction mode information for the second prediction unit indicates the luminance based color difference prediction mode, the enhancement layer prediction unit generates the predicted image in the luminance based color difference prediction mode using the coefficients.

(5)

The image processing apparatus according to (4),

wherein a spatial resolution or a density of the color difference component in the enhancement layer is higher than in the base layer, and

wherein, when a size of the second prediction unit exceeds a maximum size in which the luminance based color difference prediction mode is used, the enhancement layer prediction unit divides the second prediction unit into a plurality of sub-blocks and generates the predicted image by applying the luminance based color difference prediction mode to each of the plurality of sub-blocks using the coefficients.

(6)

The image processing apparatus according to (2),

wherein a spatial resolution or a density of the color difference component in the enhancement layer is higher than in the base layer, and

wherein, when the prediction mode information indicates the luminance based color difference prediction mode and also a size of the second prediction unit exceeds a maximum size in which the luminance based color difference prediction mode is used, the enhancement layer prediction unit generates the predicted image for the second prediction unit according to newly acquired prediction mode information.

(7)

The image processing apparatus according to any one of (1) to (6), further including:

a decoding section that decodes a parameter indicating whether the coefficients calculated for the first prediction unit are reused for the second prediction unit,

wherein, when the parameter indicates that the coefficients are reused, the enhancement layer prediction section generates the predicted image in the luminance based color difference prediction mode using the coefficients.

(8)

The image processing apparatus according to (4) or (6), further including:

a decoding section that decodes a parameter indicating whether to encode new prediction mode information for the second prediction unit,

wherein, when the parameter indicates that the new prediction mode information is encoded, the enhancement layer prediction section refers to the new prediction mode information for the second prediction unit.

(9)

The image processing apparatus according to (3) or (5), further including:

a decoding section that decodes a parameter indicating whether to divide the second prediction unit into the plurality of sub-blocks when the size of the second prediction unit exceeds the maximum size,

wherein, when the parameter indicates that the second prediction unit is to be divided into the plurality of sub-blocks, the enhancement layer prediction section divides the second prediction unit into the plurality of sub-blocks.

(10)

An image processing method including:

acquiring prediction mode information for an intra prediction of a first prediction unit of a color difference component in a base layer of an image to be scalable-decoded; and

when the prediction mode information acquired indicates a luminance based color difference prediction mode, generating a predicted image in the luminance based color difference prediction mode for a second prediction unit of the color difference component corresponding to the first prediction unit in an enhancement layer using coefficients calculated for the first prediction unit.

(11)

An image processing apparatus including:

a base layer prediction section that selects an optimum intra prediction mode for a first prediction unit of a color difference component in a base layer of an image to be scalable-encoded; and

an enhancement layer prediction section that, when a luminance based color difference prediction mode is selected by the base layer prediction section for the first prediction unit, generates a predicted image in the luminance based color difference prediction mode for a second prediction unit of the color difference component corresponding to the first prediction unit in an enhancement layer using coefficients calculated for the first prediction unit.

(12)

The image processing apparatus according to (11), wherein when the luminance based color difference prediction mode is selected for the first prediction unit, the enhancement layer prediction unit generates the predicted image in the luminance based color difference prediction mode using the coefficients without estimating a prediction mode for the second prediction unit.

(13)

The image processing apparatus according to (12),

wherein a spatial resolution or a density of the color difference component in the enhancement layer is higher than in the base layer, and

wherein, when a size of the second prediction unit exceeds a maximum size in which the luminance based color difference prediction mode is used, the enhancement layer prediction unit divides the second prediction unit into a plurality of sub-blocks and generates the predicted image by applying the luminance based color difference prediction mode to each of the plurality of sub-blocks using the coefficients.

(14)

The image processing apparatus according to (11), wherein when the luminance based color difference prediction mode is selected for the first prediction unit, the enhancement layer prediction unit estimates an optimum prediction mode from the luminance based color difference prediction mode using the coefficients and other prediction modes for the second prediction unit.

(15)

The image processing apparatus according to (14).

wherein a spatial resolution or a density of the color difference component in the enhancement layer is higher than in the base layer, and

wherein, when a size of the second prediction unit exceeds a maximum size in which the luminance based color difference prediction mode is used, the enhancement layer prediction unit divides the second prediction unit into a plurality of sub-blocks to estimate the optimum prediction mode and generates the predicted image by applying the luminance based color difference prediction mode to each of the plurality of sub-blocks using the coefficients.

(16)

The image processing apparatus according to (12) or (14),

wherein a spatial resolution or a density of the color difference component in the enhancement layer is higher than in the base layer, and

wherein, when a size of the second prediction unit exceeds a maximum size in which the luminance based color difference prediction mode is used and also the luminance based color difference prediction mode is selected for the first prediction unit, the enhancement layer prediction unit estimates an optimum prediction mode from a plurality of prediction modes excluding the luminance based color difference prediction mode for the second prediction unit.

(17)

The image processing apparatus according to any one of (11) to (16), further including:

an encoding section that encodes a parameter indicating whether the coefficients calculated for the first prediction unit are reused for the second prediction unit.

(18)

The image processing apparatus according to (11) to (17), further including:

an encoding section that encodes a parameter indicating whether to encode new prediction mode information for the second prediction unit when the luminance based color difference prediction mode is selected for the first prediction unit.

(19)

The image processing apparatus according to (13) or (15), further including:

an encoding section that encodes a parameter indicating whether to divide the second prediction unit into a plurality of sub-blocks when the size of the second prediction unit exceeds the maximum size.

(20)

An image processing method including:

selecting an optimum intra prediction mode for a first prediction unit of a color difference component in a base layer of an image to be scalable-encoded; and

when a luminance based color difference prediction mode is selected for the first prediction unit, generating a predicted image in the luminance based color difference prediction mode for a second prediction unit of the color difference component corresponding to the first prediction unit in an enhancement layer using coefficients calculated for the first prediction unit.

### REFERENCE SIGNS LIST

10 image encoding device (image processing apparatus)
40a intra prediction section (base layer prediction section)
40b intra prediction section (enhancement layer prediction section)
60 image decoding device (image processing apparatus)
90a intra prediction section (base layer prediction section)
90b intra prediction section (enhancement layer prediction section)

1. An image processing apparatus comprising:
a base layer prediction section that acquires prediction mode information for an intra prediction of a first prediction unit of a color difference component in a base layer of an image to be scalable-decoded; and
an enhancement layer prediction section that, when the prediction mode information acquired by the base layer prediction section indicates a luminance based color difference prediction mode, generates a predicted image in the luminance based color difference prediction mode for a second prediction unit of the color difference component corresponding to the first prediction unit in an enhancement layer using coefficients calculated for the first prediction unit.

2. The image processing apparatus according to claim 1, wherein, when the prediction mode information indicates the luminance based color difference prediction mode, the enhancement layer prediction unit generates the predicted image in the luminance based color difference prediction mode using the coefficients without acquiring new prediction mode information for the second prediction unit.

3. The image processing apparatus according to claim 2,
wherein a spatial resolution or a density of the color difference component in the enhancement layer is higher than in the base layer, and
wherein, when a size of the second prediction unit exceeds a maximum size in which the luminance based color difference prediction mode is used, the enhancement layer prediction unit divides the second prediction unit into a plurality of sub-blocks and generates the predicted image by applying the luminance based color difference prediction mode to each of the plurality of sub-blocks using the coefficients.

4. The image processing apparatus according to claim 1, wherein, when the prediction mode information indicates the luminance based color difference prediction mode and also newly acquired prediction mode information for the second prediction unit indicates the luminance based color difference prediction mode, the enhancement layer prediction unit generates the predicted image in the luminance based color difference prediction mode using the coefficients.

5. The image processing apparatus according to claim 4,
wherein a spatial resolution or a density of the color difference component in the enhancement layer is higher than in the base layer, and
wherein, when a size of the second prediction unit exceeds a maximum size in which the luminance based color difference prediction mode is used, the enhancement layer prediction unit divides the second prediction unit into a plurality of sub-blocks and generates the predicted image by applying the luminance based color difference prediction mode to each of the plurality of sub-blocks using the coefficients.

6. The image processing apparatus according to claim 2,
wherein a spatial resolution or a density of the color difference component in the enhancement layer is higher than in the base layer, and
wherein, when the prediction mode information indicates the luminance based color difference prediction mode and also a size of the second prediction unit exceeds a maximum size in which the luminance based color difference prediction mode is used, the enhancement layer prediction unit generates the predicted image for the second prediction unit according to newly acquired prediction mode information.

7. The image processing apparatus according to claim 1, further comprising:
a decoding section that decodes a parameter indicating whether the coefficients calculated for the first prediction unit are reused for the second prediction unit,
wherein, when the parameter indicates that the coefficients are reused, the enhancement layer prediction section generates the predicted image in the luminance based color difference prediction mode using the coefficients.

8. The image processing apparatus according to claim 4, further comprising:
a decoding section that decodes a parameter indicating whether to encode new prediction mode information for the second prediction unit,
wherein, when the parameter indicates that the new prediction mode information is encoded, the enhancement layer prediction section refers to the new prediction mode information for the second prediction unit.

9. The image processing apparatus according to claim 3, further comprising:
a decoding section that decodes a parameter indicating whether to divide the second prediction unit into the plurality of sub-blocks when the size of the second prediction unit exceeds the maximum size,
wherein, when the parameter indicates that the second prediction unit is to be divided into the plurality of sub-blocks, the enhancement layer prediction section divides the second prediction unit into the plurality of sub-blocks.

10. An image processing method comprising:
acquiring prediction mode information for an intra prediction of a first prediction unit of a color difference component in a base layer of an image to be scalable-decoded; and
when the prediction mode information acquired indicates a luminance based color difference prediction mode, generating a predicted image in the luminance based color difference prediction mode for a second prediction unit of the color difference component corresponding to the first prediction unit in an enhancement layer using coefficients calculated for the first prediction unit.

11. An image processing apparatus comprising:
a base layer prediction section that selects an optimum intra prediction mode for a first prediction unit of a color difference component in a base layer of an image to be scalable-encoded; and
an enhancement layer prediction section that, when a luminance based color difference prediction mode is selected by the base layer prediction section for the first prediction unit, generates a predicted image in the luminance based color difference prediction mode for a second prediction unit of the color difference component corresponding to the first prediction unit in an enhancement layer using coefficients calculated for the first prediction unit.

12. The image processing apparatus according to claim 11, wherein when the luminance based color difference prediction mode is selected for the first prediction unit, the enhancement layer prediction unit generates the predicted image in the luminance based color difference prediction mode using the coefficients without estimating a prediction mode for the second prediction unit.

13. The image processing apparatus according to claim 12,
wherein a spatial resolution or a density of the color difference component in the enhancement layer is higher than in the base layer, and
wherein, when a size of the second prediction unit exceeds a maximum size in which the luminance based color difference prediction mode is used, the enhancement layer prediction unit divides the second prediction unit into a plurality of sub-blocks and generates the predicted image by applying the luminance based color difference prediction mode to each of the plurality of sub-blocks using the coefficients.

14. The image processing apparatus according to claim 11, wherein when the luminance based color difference prediction mode is selected for the first prediction unit, the enhancement layer prediction unit estimates an optimum prediction mode from the luminance based color difference prediction mode using the coefficients and other prediction modes for the second prediction unit.

15. The image processing apparatus according to claim 14,
wherein a spatial resolution or a density of the color difference component in the enhancement layer is higher than in the base layer, and
wherein, when a size of the second prediction unit exceeds a maximum size in which the luminance based color difference prediction mode is used, the enhancement layer prediction unit divides the second prediction unit into a plurality of sub-blocks to estimate the optimum prediction mode and generates the predicted image by applying the luminance based color difference prediction mode to each of the plurality of sub-blocks using the coefficients.

16. The image processing apparatus according to claim 12,
wherein a spatial resolution or a density of the color difference component in the enhancement layer is higher than in the base layer, and
wherein, when a size of the second prediction unit exceeds a maximum size in which the luminance based color difference prediction mode is used and also the luminance based color difference prediction mode is selected for the first prediction unit, the enhancement layer prediction unit estimates an optimum prediction mode from a plurality of prediction modes excluding the luminance based color difference prediction mode for the second prediction unit.

17. The image processing apparatus according to claim 11, further comprising:
an encoding section that encodes a parameter indicating whether the coefficients calculated for the first prediction unit are reused for the second prediction unit.

18. The image processing apparatus according to claim 11, further comprising:
an encoding section that encodes a parameter indicating whether to encode new prediction mode information for the second prediction unit when the luminance based color difference prediction mode is selected for the first prediction unit.

19. The image processing apparatus according to claim 13, further comprising:
an encoding section that encodes a parameter indicating whether to divide the second prediction unit into a plurality of sub-blocks when the size of the second prediction unit exceeds the maximum size.

20. An image processing method comprising:
selecting an optimum intra prediction mode for a first prediction unit of a color difference component in a base layer of an image to be scalable-encoded; and
when a luminance based color difference prediction mode is selected for the first prediction unit, generating a predicted image in the luminance based color difference prediction mode for a second prediction unit of the color difference component corresponding to the first prediction unit in an enhancement layer using coefficients calculated for the first prediction unit.
